(19) United States
(12) Patent Application Publication
(10) Pub. No.: US 2026/0170188 A1
(43) Pub. Date: Jun. 18, 2026

(54) AUTOMATED DESIGN AND MANUFACTURE OF FURNITURE

(71) Applicant: Shelf.Me LLC, Seattle, WA (US)

(72) Inventor: Peter Rahemtulla Godman, Seattle, WA (US)

(21) Appl. No.: 19/421,821

(22) Filed: Dec. 16, 2025

Related U.S. Application Data
(60) Provisional application No. 63/734,639, filed on Dec. 16, 2024.

(51) Int. Cl. G06F 30/12; G06F 30/17; G06F 119/18

(52) U.S. Cl. CPC G06F 30/12; G05B 19/4097; G06F 30/17; G06F 2119/18

(57) ABSTRACT

A software platform that employs rules-based grammar, real-time constraint solving, and dynamic three-dimensional visualizations, so that customers can experiment with configurations of furniture and cabinetry. Customers can virtually apply stylistic preferences to new furniture designs. Once the new furniture design is finalized, the customer may place an order in a virtual shopping cart that provides a variety of payment options. Upon completion of payment, the platform automatically manages the procurement of materials, manufacture and delivery of the custom designed furniture to the customer. The delivered furniture may be assembled by the user or by a contracted service technician.

### CROSS-REFERENCE TO RELATED APPLICATION

This application is a Utility Patent application based on previously filed U.S. Provisional Patent Application No. 63/734,639 filed on Dec. 16, 2024. The benefit of the filing date of this provisional application is hereby claimed under 35 U.S.C. § 119 (e) and the contents of this provisional application is herein incorporated by reference in its entirety.

### TECHNICAL FIELD

The various embodiments disclosed herein generally relates to online virtual design, customization, and manufacture of custom furniture. More specifically, the various embodiments related to an online platform for users to design, customize and procure manufacture of bespoke furniture and cabinetry that is delivered to customers for assembly.

### BACKGROUND

Historically, a large division of work has existed between technical procurement specialists and their customers such as individuals and interior designers. Typically, the customers create a customized design for furniture/cabinetry with specific dimensions, which is handed off to the technical procurement specialists. Generally, the sourcing of the physical materials, managing the manufacture of the custom designed furniture/cabinetry, and scheduling delivery to the customer is a separate process opaquely managed by a technical procurement specialist. The historic division between the custom design process and the procurement process increases the cost to customers and limits their access to a wider range of custom designs.

### BRIEF DESCRIPTION OF THE DRAWINGS

FIG. 1 illustrates a system environment in which various embodiments may be implemented;

FIG. 2 shows a schematic environment of a client computer;

FIG. 3 depicts a schematic environment of a network computer;

FIG. 4 shows an exemplary three-dimensional schematic view of a tenon that is complementary to a mortise;

FIG. 5 depicts an exemplary three-dimensional schematic view of a mortise that is complementary to a tenon;

FIG. 6 shows an exemplary three-dimensional view of four different potential ways to join two panels to enable determination of an optimal allocation of tenons and mortises to facilitate easy joining of the two panels;

FIG. 7 depicts an exemplary three-dimensional visualization mode for the joining steps of panels presented to the user in a user interface;

FIG. 8 shows a three-dimensional (3D) view of an item of new furniture that provides access to various views and assembly instructions;

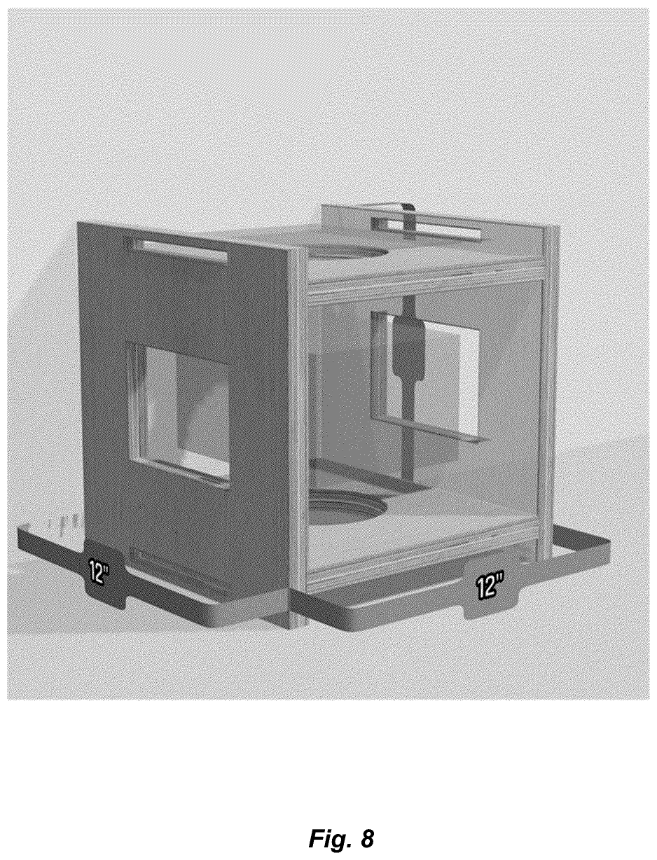

FIG. 9 depicts a logical architecture of a system for automated design, recommendations, evaluation, scheduling, manufacturing and delivery of custom designed furniture for assembly by customers based on real time information collected in accordance with one or more of the various embodiments;

FIG. 10 illustrates an overview flowchart of a process for real time analysis and manufacture of custom designed furniture in accordance with one or more of the various embodiments;

FIG. 11 illustrates a flowchart of a process for real time analysis, recommendations and evaluation of custom designed furniture by generative Artificial Intelligence in accordance with one or more of the various embodiments; and

FIG. 12 illustrates a flowchart of a process for collecting and applying telemetry information and telemetry metrics for designing, scheduling and manufacturing items in accordance with one or more of the various embodiments.

### BRIEF DESCRIPTION OF VARIOUS EMBODIMENTS

Various embodiments now will be described more fully hereinafter with reference to the accompanying drawings, which form a part hereof, and which show, by way of illustration, specific exemplary embodiments by which these innovations may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of these innovations

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example, embodiments, the following terms are also used herein according to the corresponding meaning, unless the context clearly dictates otherwise.

As used herein the term, “engine” refers to logic embodied in hardware or software instructions, which can be written in a programming language, such as C, C++, Objective-C, COBOL, Java, PHP, Perl, Python, R, Julia, JavaScript, Ruby, VBScript, Microsoft .NET languages such as C#, or the like. An engine may be compiled into executable programs or written in interpreted programming languages. Software engines may be callable from other engines or from themselves. Engines described herein refer to one or more logical modules that can be merged with other engines or applications, or can be divided into sub-engines. The engines can be stored in non-transitory computer-readable medium or computer storage device and be stored on and executed by one or more general purpose computers, thus creating a special purpose computer configured to provide the engine.

As used herein, the terms “large language model,” or “LLM” refer to data structures, programs, or the like, that may be trained or designed to perform a variety of natural language processing tasks. Typically, LLMs may generate text responses in response to text based prompts. Often, LLMs may be considered to be neural networks that have been trained on large collections of natural language source documents. Accordingly, in some cases, LLMs may be trained to generate predictive responses based on provided prompts. LLM prompts may include context information, examples, or the like, that may enable LLMs to generate responses directed to specific queries or particular problems that go beyond conventional NLP.

As used herein, the terms “prompt, or “prompt dataset” refer to one or more data structures that contain or represent prompt information that may be provided to LLMs.

As used herein, the terms “generative artificial intelligence,” “generative AI,” refer to data structures, models, programs, services, or the like that may be trained or designed to perform a variety of data analysis tasks. Typically, generative AI systems may generate responses in response to provided prompts. Often, generative AI may be considered to include neural networks or transformers that have been trained or tuned on large collections of training documents. Accordingly, in some cases, generative AI may be trained to generate predictive responses based on provided prompts. Generative AI prompts may include context information, examples, or the like, that may enable generative AIs to generate responses directed to specific queries or particular problems that go beyond conventional machine learning or other conventional techniques. In some cases, generative AI may include or be referred to as large language models (LLMs). Note, innovation herein should not be considered to be limited to using particular generative AI modeling techniques as these are anticipated to change or evolve overtime.

As used herein, the term, “configuration information” refers to information that may include rule based policies, pattern matching, scripts (e.g., computer readable instructions), or the like, that may be provided from various sources, including, configuration files, databases, user input, built-in defaults, or the like, or combination thereof. In some cases, configuration information may include or reference information stored in other systems or services, such as, configuration management databases, Lightweight Directory Access Protocol (LDAP) servers, name services, public key infrastructure services, or the like.

The following briefly describes embodiments of these innovations to provide a basic understanding of some aspects of these innovations. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are disclosed herein for an online platform that provides tools and services for customers to design and procure the manufacture of custom furniture, including shelving, bookcases, bureaus, cabinetry, case goods, and personalized furniture. The platform integrates advanced constraint-solving technologies and large language models with user-friendly interfaces, to empower customers to create bespoke furniture solutions for residences and/or businesses that are designed to be both highly functional and visually stunning. Further, the platform is easily accessible, highly efficient, and enjoyable for a wide range of customers to create attractive designs for efficiently manufactured highly customed furniture that can be assembled without the use of fasteners or adhesives, e.g., no nails, screws, bolts, glue, or the like area required to fully assemble the custom furniture provided to the customer by this platform.

Additionally, various embodiments of the platform bridges the gap between intuitive design and precise just in time manufacturing. Through a system of rules-based grammar, real-time constraint solving, and dynamic 3D visualizations, and artificial intelligence, the customers can experiment with a wide variety of configurations, materials, finishes, and stylistic preferences. Once the design is confirmed, the customer may subsequently order the manufacture and schedule delivery of furniture that can be readily assembled with specifically engineered compression joins, e.g., slide tendon and mortise joins. With just a rubber mallet, the customer can fully assemble the custom furniture without the use of adhesives and/or traditional tools, such as hammers, screwdrivers, wrenches, or drills.

Also, various embodiments of the platform include an online user interface that provides access to advanced design tools and intuitive controls. For example, users of the platform can create shelving systems by selecting, modifying, and combining elements such as panels, voids, and stacks. These designs are guided by a robust grammar that enforces structural integrity, aesthetic harmony, and manufacturing constraints. Further, once a design is finalized by a user, she may visualize the assembly process, export detailed specifications, and place orders for manufacture and delivery directly through the platform.

### Illustrative Operating Environment

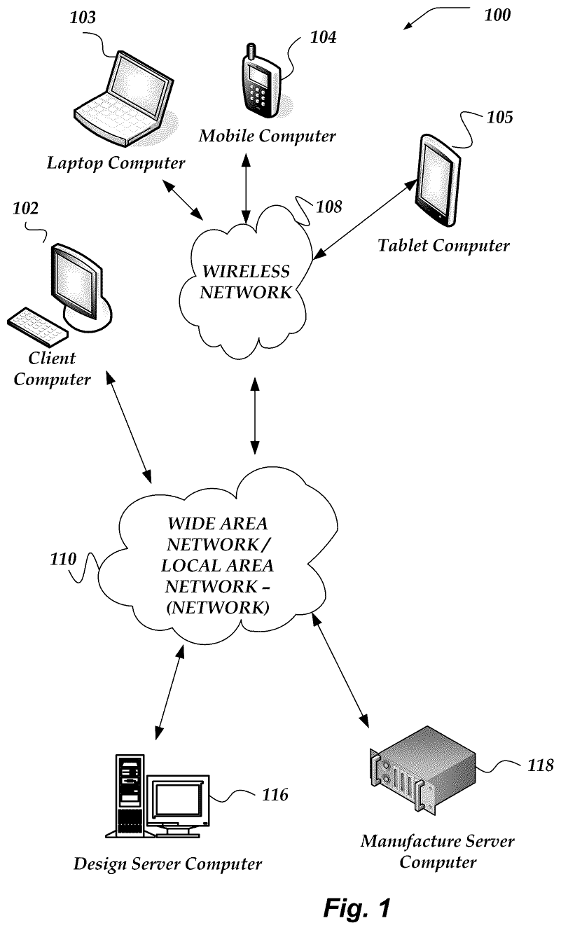

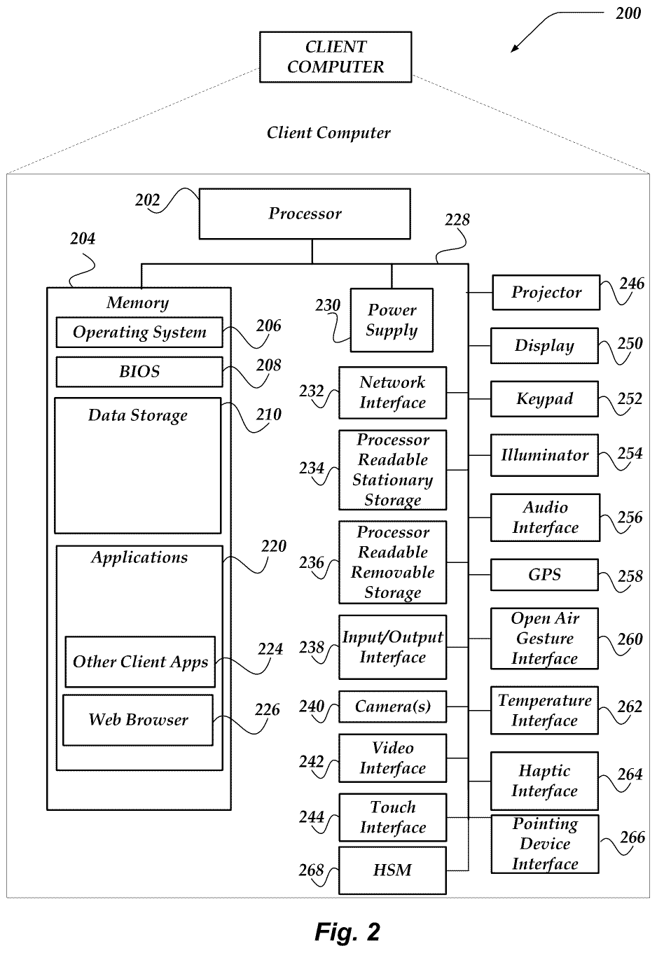

FIG. 1 shows components of one embodiment of an environment in which embodiments of the innovations disclosed herein may be practiced. Not all of the components may be required to practice these innovations, and variations in the arrangement and type of the components may be made without departing from the spirit or scope of these innovations. As shown, system 100 of FIG. 1 includes local area networks (LANs)/wide area networks (WANs)-(network) 110, wireless network 108, client computers 102-105, design server computer 116, manufacturing server computer 118, or the like. At least one embodiment of client computers 102-105 is described in more detail below in conjunction with FIG. 2. In one embodiment, at least some of client computers 102-105 may operate over one or more wired or wireless networks, such as networks 108, or 110.

Generally, client computers 102-105 may include virtually any computer capable of communicating over a network to send and receive information, perform various online activities, offline actions, or the like. In one embodiment, one or more of client computers 102-105 may be configured to operate within a business or other entity to perform a variety of services for the business or other entity. For example, client computers 102-105 may be configured to operate as a web server, firewall, client application, media player, mobile telephone, game console, desktop computer, or the like. However, client computers 102-105 are not constrained to these services and may also be employed, for example, as for end-user computing in other embodiments. It should be recognized that more or less client computers (as shown in FIG. 1) may be included within a system as described herein, and embodiments are therefore not constrained by the number or type of client computers employed.

Computers that may operate as client computer 102 may include computers that typically connect using a wired or wireless communications medium such as personal computers, multiprocessor systems, microprocessor-based or programmable electronic devices, network PCs, or the like. In some embodiments, client computers 102-105 may include virtually any portable computer capable of connecting to another computer and receiving information such as, laptop computer 103, mobile computer 104, tablet computers 105, or the like. However, portable computers are not so limited and may also include other portable computers such as cellular telephones, display pagers, radio frequency (RF) devices, infrared (IR) devices, Personal Digital Assistants (PDAs), handheld computers, wearable computers, integrated devices combining one or more of the preceding computers, or the like. As such, client computers 102-105 typically range widely in terms of capabilities and features. Moreover, client computers 102-105 may access various computing applications, including a browser, or other web-based application.

A web-enabled client computer may include a browser application that is configured to send requests and receive responses over the web. The browser application may be configured to receive and display graphics, text, multimedia, and the like, employing virtually any web-based language. In one embodiment, the browser application is enabled to employ JavaScript, HyperText Markup Language (HTML), extensible Markup Language (XML), JavaScript Object Notation (JSON), Cascading Style Sheets (CSS), or the like, or combination thereof, to display and send a message. In one embodiment, a user of the client computer may employ the browser application to perform various activities over a network (online). However, another application may also be used to perform various online activities.

Client computers 102-105 also may include at least one other client application that is configured to receive or send content between another computer. The client application may include a capability to send or receive content, or the like. The client application may further provide information that identifies itself, including a type, capability, name, and the like. In one embodiment, client computers 102-105 may uniquely identify themselves through any of a variety of mechanisms, including an Internet Protocol (IP) address, a phone number, Mobile Identification Number (MIN), an electronic serial number (ESN), a client certificate, or other device identifier. Such information may be provided in one or more network packets, or the like, sent between other client computers, design server computer 116, manufacture server computer 118, or other computers.

Client computers 102-105 may further be configured to include a client application that enables an end-user to log into an end-user account that may be managed by another computer, such as design server computer 116, manufacture server computer 118, or the like. Such an end-user account, in one non-limiting example, may be configured to enable the end-user to manage one or more online activities, including in one non-limiting example, project management, software development, system administration, configuration management, search activities, social networking activities, browse various websites, communicate with other users, or the like. Further, client computers may be arranged to enable users to provide configuration information, policy information, or the like, to design server computer 116 and/or manufacture server computer 118. Also, client computers may be arranged to enable users to display reports, interactive user-interfaces, results provided by design server computer 116 and/or manufacture server computer 118, or the like. Wireless network 108 is configured to couple client computers 103-105 and its components with network 110. Wireless network 108 may include any of a variety of wireless sub-networks that may further overlay stand-alone ad-hoc networks, and the like, to provide an infrastructure-oriented connection for client computers 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G), 5th (5G), 6th (6G) generation radio access for cellular systems, WLAN, Wireless Router (WR) mesh, and the like. Access technologies such as 2G, 3G, 4G, 5G, 6G and future access networks may enable wide area coverage for mobile computers, such as client computers 103-105 with various degrees of mobility. In one non-limiting example, wireless network 108 may enable a radio connection through a radio network access such as Global System for Mobile communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client computers 103-105 and another computer, network, a cloud-based network, a cloud instance, or the like.

Network 110 is configured to couple network computers with other computers, including, design server computer 116, manufacture server computer 118, client computers 102-105 through wireless network 108, or the like. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, Ethernet port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information using one or more network protocols, such Internet Protocol (IP).

Additionally, communication media typically embodies computer readable instructions, data structures, program modules, or other transport mechanism and includes any information non-transitory delivery media or transitory delivery media. By way of example, communication media includes wired media such as twisted pair, coaxial cable, fiber optics, wave guides, and other wired media and wireless media such as acoustic, RF, infrared, and other wireless media.

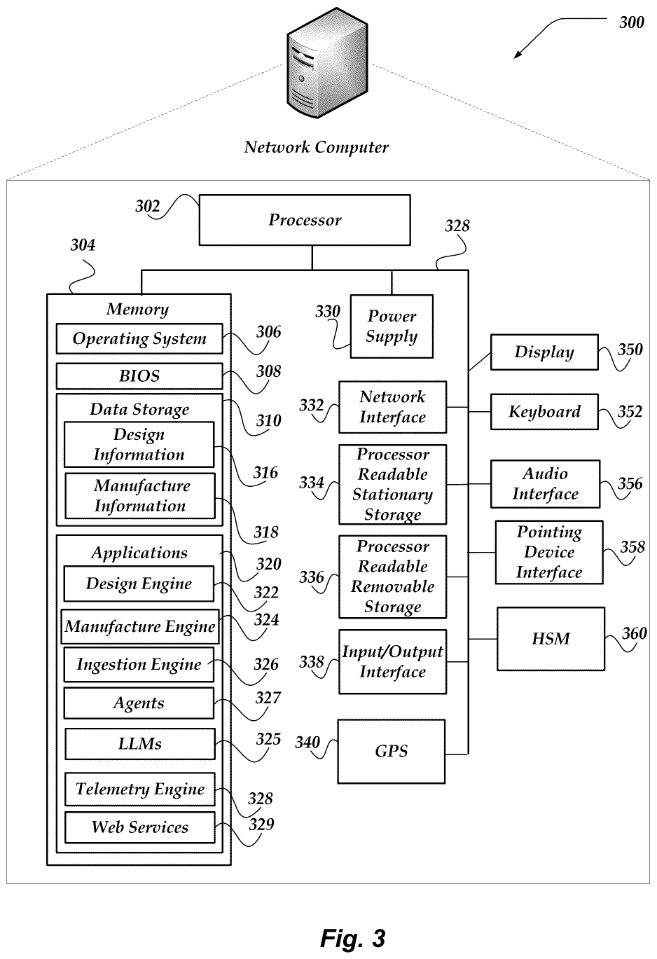

One embodiment of design server computer 116, and manufacture server computer 118 are described in more detail below in conjunction with FIG. 3. Although FIG. 1 illustrates design server computer 116, or manufacture server computer 118 each as a single computer, the innovations or embodiments are not so limited. For example, one or more functions of design server computer 116, or manufacture server computer 118, or the like, may be distributed across one or more distinct network computers. Moreover, in one or more embodiments, manufacture server computer 118 may be implemented using a plurality of network computers. Further, in one or more of the various embodiments, design server computer 116, or manufacture server computer 118 may be implemented using one or more cloud instances in one or more cloud networks. Accordingly, these innovations and embodiments are not to be construed as being limited to a single environment, and other configurations, and other architectures are also envisaged.

### Illustrative Client Computer

FIG. 2 shows one embodiment of client computer 200 that may include many more or less components than those shown. Client computer 200 may represent, for example, at least one embodiment of mobile computers or client computers shown in FIG. 1. Client computer 200 may include processor 202 in communication with memory 204 via bus 228. Client computer 200 may also include power supply 230, network interface 232, audio interface 256, display 250, keypad 252, illuminator 254, video interface 242, input/output interface 238, haptic interface 264, global positioning systems (GPS) receiver 258, open air gesture interface 260, temperature interface 262, camera(s) 240, projector 246, pointing device interface 266, processor-readable stationary storage device 234, and processor-readable removable storage device 236. Client computer 200 may optionally communicate with a base station (not shown), or directly with another computer. And in one embodiment, although not shown, a gyroscope may be employed within client computer 200 for measuring or maintaining an orientation of client computer 200.

Power supply 230 may provide power to client computer 200. A rechargeable or non-rechargeable battery may be used to provide power. The power may also be provided by an external power source, such as an AC adapter or a powered docking cradle that supplements or recharges the battery.

Network interface 232 includes circuitry for coupling client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 232 is sometimes known as a transceiver, transceiving device, or network interface card (NIC).

Audio interface 256 may be arranged to produce and receive audio signals such as the sound of a human voice. For example, audio interface 256 may be coupled to a speaker and microphone (not shown) to enable telecommunication with others or generate an audio acknowledgement for some action. A microphone in audio interface 256 can also be used for input to or control of client computer 200, e.g., using voice recognition, detecting touch based on sound, and the like.

Display 250 may be a liquid crystal display (LCD), gas plasma, electronic ink, light emitting diode (LED), Organic LED (OLED) or any other type of light reflective or light transmissive display that can be used with a computer. Display 250 may also include a touch interface 244 arranged to receive input from an object such as a stylus or a digit from a human hand, and may use resistive, capacitive, surface acoustic wave (SAW), infrared, radar, or other technologies to sense touch or gestures.

Projector 246 may be a remote handheld projector or an integrated projector that is capable of projecting an image on a remote wall or any other reflective object such as a remote screen.

Video interface 242 may be arranged to capture video images, such as a still photo, a video segment, an infrared video, or the like. For example, video interface 242 may be coupled to a digital video camera, a web-camera, or the like. Video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 252 may comprise any input device arranged to receive input from a user. For example, keypad 252 may include a push button numeric dial, or a keyboard. Keypad 252 may also include command buttons that are associated with selecting and sending images.

Illuminator 254 may provide a status indication or provide light. Illuminator 254 may remain active for specific periods of time or in response to event messages. For example, when illuminator 254 is active, it may backlight the buttons on keypad 252 and stay on while the client computer is powered. Also, illuminator 254 may backlight these buttons in various patterns when particular actions are performed, such as dialing another client computer. Illuminator 254 may also cause light sources positioned within a transparent or translucent case of the client computer to illuminate in response to actions.

Further, client computer 200 may also comprise hardware security module (HSM) 268 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 268 may be a stand-alone computer, in other cases, HSM 268 may be arranged as a hardware card that may be added to a client computer.

Client computer 200 may also comprise input/output interface 238 for communicating with external peripheral devices or other computers such as other client computers and network computers. The peripheral devices may include an audio headset, virtual reality headsets, display screen glasses, remote speaker system, remote speaker and microphone system, and the like. Input/output interface 238 can utilize one or more technologies, such as Universal Serial Bus (USB), Infrared, WiFi, WiMax, Bluetooth™, and the like.

Input/output interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to client computer 200.

Haptic interface 264 may be arranged to provide tactile feedback to a user of the client computer. For example, the haptic interface 264 may be employed to vibrate client computer 200 in a particular way when another user of a computer is calling. Temperature interface 262 may be used to provide a temperature measurement input or a temperature changing output to a user of client computer 200. Open air gesture interface 260 may sense physical gestures of a user of client computer 200, for example, by using single or stereo video cameras, radar, a gyroscopic sensor inside a computer held or worn by the user, or the like. Camera 240 may be used to track physical eye movements of a user of client computer 200.

GPS transceiver 258 can determine the physical coordinates of client computer 200 on the surface of the Earth, which typically outputs a location as latitude and longitude values. GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 200 on the surface of the Earth. It is understood that under different conditions, GPS transceiver 258 can determine a physical location for client computer 200. In one or more embodiments, however, client computer 200 may, through other components, provide other information that may be employed to determine a physical location of the client computer, including for example, a Media Access Control (MAC) address, IP address, and the like.

Human interface components can be peripheral devices that are physically separate from client computer 200, allowing for remote input or output to client computer 200. For example, information routed as described here through human interface components such as display 250 or keyboard 252 can instead be routed through network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth, Zigbee, or the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include web browser application 226 that is configured to receive and to send web pages, web-based messages, graphics, text, multimedia, and the like. The client computer's browser application may employ virtually any programming language, including a wireless application protocol messages (WAP), and the like. In one or more embodiment, the browser application is enabled to employ Handheld Device Markup Language (HDML), Wireless Markup Language (WML), WMLScript, JavaScript, Standard Generalized Markup Language (SGML), HyperText Markup Language (HTML), extensible Markup Language (XML), HTML5, and the like.

Memory 204 may include RAM, ROM, or other types of memory. Memory 204 illustrates an example of computer-readable storage media (devices) for storage of information such as computer-readable instructions, data structures, program modules or other data. Memory 204 may store BIOS 208 for controlling low-level operation of client computer 200. The memory may also store operating system 206 for controlling the operation of client computer 200. It will be appreciated that this component may include a general-purpose operating system such as a version of UNIX®, or Linux®, or a specialized client computer communication operating system such as Windows Phone™, or the Symbian® operating system. The operating system may include, or interface with a Java virtual machine module that enables control of hardware components or operating system operations via Java application programs.

Memory 204 may further include one or more data storage 210, which can be utilized by client computer 200 to store, among other things, applications 220 or other data. For example, data storage 210 may also be employed to store information that describes various capabilities of client computer 200. The information may then be provided to another device or computer based on any of a variety of methods, including being sent as part of a header during a communication, sent upon request, or the like. Data storage 210 may also be employed to store social networking information including address books, buddy lists, aliases, user profile information, or the like. Data storage 210 may further include program code, data, algorithms, and the like, for use by processors, such as processor 202 to execute and perform actions. In one embodiment, at least some of data storage 210 might also be stored on another component of client computer 200, including, but not limited to, non-transitory processor-readable removable storage device 236, processor-readable stationary storage device 234, or even external to the client computer.

Applications 220 may include computer executable instructions which, when executed by client computer 200, transmit, receive, or otherwise process instructions and data. Applications 220 may include, for example, other client applications 224, web browser 226, or the like. Client computers may be arranged to exchange communications, such as, queries, searches, messages, notification messages, event messages, alerts, log data, API calls, or the like, combination thereof, with application servers. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), client computer 200 may include one or more embedded logic hardware devices instead of CPUs, such as, an Application Specific Integrated Circuit (ASIC), Field Programmable Gate Array (FPGA), Programmable Array Logic (PAL), or the like, or combination thereof. The embedded logic hardware devices may directly execute embedded logic to perform actions. Also, in one or more embodiments (not shown in the figures), client computer 200 may include one or more hardware microcontrollers instead of CPUs. In one or more embodiments, the microcontrollers may directly execute their own embedded logic to perform actions and access their own internal memory and their own external Input and Output Interfaces (e.g., hardware pins or wireless transceivers) to perform actions, such as System On a Chip (SOC), or the like.

### Illustrative Network Computer

FIG. 3 shows one embodiment of network computer 300 that may be included in a system implementing at least one of the various embodiments. Network computer 300 may include many more or less components than those shown in FIG. 3. However, the components shown are sufficient to disclose an illustrative embodiment for practicing these innovations. Network computer 300 may represent, for example, one embodiment of at least one of design server computer 116, manufacture server computer 118 shown in FIG. 1.

In As shown in the figure, network computer 300 includes a processor 302 that may be in communication with a memory 304 via a bus 328. In some embodiments, processor 302 may be comprised of one or more hardware processors, or one or more processor cores. In some cases, one or more of the one or more processors may be specialized processors designed to perform one or more specialized actions, such as, those described herein. Network computer 300 also includes a power supply 330, network interface 332, audio interface 356, display 350, keyboard 352, input/output interface 338, processor-readable stationary storage device 334, and processor-readable removable storage device 336. Power supply 330 provides power to network computer 300.

FIG. 3 shows one embodiment of network computer 300 that may be included in a system implementing at least one of the various embodiments. Network computer 300 may include many more or less components than those shown in FIG. 3. However, the components shown are sufficient to disclose an illustrative embodiment for practicing these innovations. Network computer 300 may represent, for example, one embodiment of at least one of design server computer 116, manufacture server computer 118 shown in FIG. 1. In some embodiments, processor-readable stationary storage device 334 or processor-readable removable storage device 336 may be considered a processor or computer readable non-transitory storage media that includes instructions configured for obtaining dynamic investigation playbooks in a computing environment such that execution of the instructions by one or more processors on one or more network computers performs actions described herein.

Network interface 332 includes circuitry for coupling network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. Network interface 332 is sometimes known as a transceiver, transceiving device, or network interface card (NIC). Network computer 300 may optionally communicate with a base station (not shown), or directly with another computer.

Audio interface 356 is arranged to produce and receive audio signals such as the sound of a human voice. For example, audio interface 356 may be coupled to a speaker and microphone (not shown) to enable telecommunication with others or generate an audio acknowledgement for some action. A microphone in audio interface 356 can also be used for input to or control of network computer 300, for example, using voice recognition.

Display 350 may be a liquid crystal display (LCD), gas plasma, electronic ink, light emitting diode (LED), Organic LED (OLED) or any other type of light reflective or light transmissive display that can be used with a computer. In some embodiments, display 350 may be a handheld projector or pico projector capable of projecting an image on a wall or other object.

Network computer 300 may also comprise input/output interface 338 for communicating with external devices or computers not shown in FIG. 3. Input/output interface 338 can utilize one or more wired or wireless communication technologies, such as USB™, Firewire™, WiFi, WiMax, Thunderbolt™, Infrared, Bluetooth™, Zigbee™, serial port, parallel port, and the like.

Also, input/output interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to network computer 300. Human interface components can be physically separate from network computer 300, allowing for remote input or output to network computer 300. For example, information routed as described here through human interface components such as display 350 or keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through pointing device interface 358 to receive user input.

GPS transceiver 340 can determine the physical coordinates of network computer 300 on the surface of the Earth, which typically outputs a location as latitude and longitude values. GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of network computer 300 on the surface of the Earth. It is understood that under different conditions, GPS transceiver 340 can determine a physical location for network computer 300. In one or more embodiment, however, network computer 300 may, through other components, provide other information that may be employed to determine a physical location of the network computer or client computers, including for example, a Media Access Control (MAC) address, IP address, and the like.

In at least one of the various embodiments, applications, such as, operating system 306, design engine 322, manufacture engine 324, LLMs 325, ingestion engine 326, agents 327, telemetry engine 328, web services 329, or the like, may be arranged to employ geo-location information to select one or more localization features, such as, time zones, languages, currencies, calendar formatting, or the like. Also, localization features may be used when interpreting network traffic, application protocols, user-interfaces, generating reports, monitoring infrastructure access in different regions, or the like. Localization may be employed by one or more internal processes or databases. In at least one of the various embodiments, geo-location information used for selecting localization information may be provided by GPS 340. Also, in some embodiments, geolocation information may include information provided using one or more geolocation protocols over the networks, such as, wireless network 108 or network 111.

Memory 304 may include Random Access Memory (RAM), Read-Only Memory (ROM), or other types of memory. Memory 304 illustrates an example of computer-readable storage media (devices) for storage of information such as computer-readable instructions, data structures, program modules or other data. Memory 304 stores a basic input/output system (BIOS) 308 for controlling low-level operation of network computer 300. The memory also stores operating system 306 for controlling the operation of network computer 300. It will be appreciated that this component may include a general-purpose operating system such as a version of UNIX®, or Linux®, or a specialized operating system such as Microsoft Corporation's Windows® operating system, or the Apple Corporation's IOS operating system. Operating systems may include, or interface with a Java virtual machine module that enables control of hardware components or operating system operations via Java application programs. Likewise, other runtime environments may be included.

Memory 304 may further include one or more data storage 310, which can be utilized by network computer 300 to store, among other things, applications 320 or other data. For example, data storage 310 may also be employed to store information that describes various capabilities of network computer 300. The information may then be provided to another device or computer based on any of a variety of methods, including being sent as part of a header during a communication, sent upon request, or the like. Data storage 310 may also be employed to store social networking information including address books, buddy lists, aliases, user profile information, or the like. Data storage 310 may further include program code, data, algorithms, and the like, for use by a processor, such as processor 302 to execute and perform actions such as those actions described below. In one embodiment, at least some of data storage 310 might also be stored on another component of network computer 300, including, but not limited to, non-transitory media inside processor-readable removable storage device 336, processor-readable stationary storage device 334, or any other computer-readable storage device within network computer 300, or even external to network computer 300. Data storage 310 may include, for example, design information 316, manufacture information 318, or the like.

Applications 320 may include computer executable instructions which, when executed by network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. Applications 320 may include design engine 322, manufacture engine 324, LLMs 325, ingestion engine 326, agents 327, telemetry engine 328, web services 329, or the like, that may be arranged to perform actions for embodiments described below. In one or more of the various embodiments, one or more of the applications may be implemented as modules or components of another application. Further, in one or more of the various embodiments, applications may be implemented as operating system extensions, modules, plugins, or the like.

Furthermore, in one or more of the various embodiments, design engine 322, manufacture engine 324, LLMs 325, ingestion engine 326, agents 327, telemetry engine 328, web services 329, or the like, may be operative in a cloud-based computing environment. In one or more of the various embodiments, these applications, and others may be executing within virtual machines or virtual servers that may be managed in a cloud-based computing environment. In one or more of the various embodiments, in this context the applications may flow from one physical network computer within the cloud-based environment to another depending on performance and scaling considerations automatically managed by the cloud computing environment. Likewise, in one or more of the various embodiments, virtual machines or virtual servers dedicated to design engine 322, manufacture engine 324, LLMs 325, ingestion engine 326, agents 327, telemetry engine 328, web services 329, or the like, may be provisioned and de-commissioned automatically.

Also, in one or more of the various embodiments, design engine 322, manufacture engine 324, LLMs 325, ingestion engine 326, agents 327, telemetry engine 328, web services 329, or the like, may be located in virtual servers running in a cloud-based computing environment rather than being tied to one or more specific physical network computers. Likewise, in some embodiments, one or more of design engine 322, manufacture engine 324, LLMs 325, ingestion engine 326, agents 327, telemetry engine 328, web services 329, or the like, may be configured to execute in a container-based environment.

Further, network computer 300 may also comprise hardware security module (HSM) 360 for providing additional tamper resistant safeguards for generating, storing or using security/cryptographic information such as, keys, digital certificates, passwords, passphrases, two-factor authentication information, or the like. In some embodiments, hardware security modules may be employed to support one or more standard public key infrastructures (PKI), and may be employed to generate, manage, or store keys pairs, or the like. In some embodiments, HSM 360 may be a stand-alone network computer, in other cases, HSM 360 may be arranged as a hardware card that may be installed in a network computer.

Additionally, in one or more embodiments (not shown in the figures), network computer 300 may include one or more embedded logic hardware devices instead of CPUs, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include one or more hardware microcontrollers instead of CPUs. In one or more embodiments, the one or more microcontrollers may directly execute their own embedded logic to perform actions and access their own internal memory and their own external Input and Output Interfaces (e.g., hardware pins or wireless transceivers) to perform actions, such as System On a Chip (SOC), or the like.

### Illustrative Platform Features And Components

For the various embodiments, features may include one or more of the following:
Real-Time Constraint Solving: Ensures designs are manufacturable and meet user-defined specifications;
Grammar-Directed Design: Provides a flexible yet controlled environment for defining relationships between elements;
Collaborative Editing: Supports multiple users working simultaneously on the same design; and
Dynamic Visualization: Offers 3D rendering and assembly animations for clear design communication.

Additionally, the various embodiments of the platform are built on a software architecture that integrates several key technologies, including one or more of the following components.

### 1. PITA (Piecewise-Idempotent Transformer Architecture);

A modular framework that transforms and optimizes a hierarchical tree structure of elements (e.g., panels, voids, stacks).
Supports idempotent transformations, ensuring minimal re-computation when changes are made.
Integrates annotation systems to track element properties, constraints, and styles.

### 2. Emu Linear Constraint Solver:

A robust solver based on the Cassowary algorithm, enhanced for immutability and rational arithmetic.
Ensures precision and stability in resolving constraints, enabling real-time feedback during design.

### 3. Grammar System:

Defines allowable relationships between elements using a formal grammar.
Guides user modifications, such as adjusting the number of shelves or switching element types, while maintaining consistency with the overall design.

### 4. State Window Functions:

Optimizes re-computation by isolating state changes to affected parts of the design, significantly improving performance.

### 5. Collaborative History System:

Tracks user edits in a reducer-based system with an attached history.
Synchronizes changes across users and sessions using a “concept time” ordering, enabling seamless collaborative design.

### 6. Joinery System:

Implements a hardware-free slide tenon-and-mortise design, enabling seamless assembly with precise Computer Numerical Control (CNC) machines for the manufacture of components that may be composed of a solid material such as veneer plywood, plywood, solid wood, particle board wood, metal, plastic, stone, polymer, composite materials, and the like. Alternatively, the various embodiments of the joinery system for the platform may also be employed to manufacture pouring molds for new designs of components for furniture/cabinetry or structural elements, e.g., counters, sinks, showers, bathtubs, walls, ramps, floors. The pouring molds may be used with various types of materials associated with a state change from a liquid to a solid at ambient temperatures, such as concrete, metal, ceramics, plastic, polymers, composite materials, and the like.
Includes a dual-lock mechanism (tooth-slot and channel-ridge) and an active registration system for precise alignment during assembly.

This architecture is designed for scalability, allowing users to create complex designs while maintaining high performance and precision. By combining these elements, the various embodiments of the platform offer a robust application for both creative exploration and practical design of furniture and cabinetry.

### Overview Of Components For The Platform

### I. Emu

Emu is a linear constraint solver based on Cassowary. Its basic features:
It allows the addition and removal of constraints that reference variables by name (though they are represented by numbers internally)
It prioritizes constraints using numbers. Internally, these priorities are maintained by keeping an objective function with lexicographic weights, as per the original Cassowary design, and in contrast to most implementations of Cassowary.
It implements the solver as an immutable data structure (though it has a with Mutations mode) allowing the solver to be examined in pre-modification and post-modification states.
It is entirely implemented with rational number arithmetic, allowing for perfect precision and detected overflow conditions.

### II. Pita

PITA is the Piecewise-idempotent-transformer-architecture. It comprises the following parts:
1. An element, which is a component of a shelving system or room description: for example a panel, a void, or a stack.
   1. In transformation, elements are not rewritten unless they change. This is the minimal modification principle.
2. A tree, which is a tree of elements.
   1. Trees may be efficiently differenced against another tree by referential equality due to the minimal modification principle.
3. Annotations, which are fields on elements that are defined exterior to the element. For example, the value of a bound of a panel is an annotation (in this case boundsValue), describing {axis, start|end}⇒Rational.
   1. Elements logical clocks that describe the logical time at which annotations were last modified, and also the highest logical time for an annotation under a certain place in the tree.
   2. Annotations are not rewritten when they are unchanged relative to an equals operator, enforcing the minimal modification principle.
4. A transformation, which:
   1. consumes input and output annotations (described below), which describe, for an element, which of its annotations are to be read, and which written (and read)
   2. has operations to be performed on an element in pre- and post-traversal order
   3. has its own internal state that is maintained from invocation to invocation, as the transformation system moves up and down the element tree, transforming
   4. can declare whether it is idempotent or not
5. A mutation, which is a piece of code which, when applied to a single element, maps input to output annotations. This is wrapped by a transformer adapter and thus turned into a transformation. This exists just to reduce transformer boilerplate.
6. A transform system, which applies a single transformation to a tree
   1. This transform system may cache whether a certain idempotent transformer with specific internal state has already been applied to a given set of annotations, by way of using the logical clocks previously described. This allows large sections of the work space to be pruned away.
7. Flows, which are sets of transformers, along with repeating dispositions. So, a set of transformers may be declared. Given a set of known-modified annotations, a static analysis system can (and does) reduce the set of transformers to just ones which could have an effect. Figure A1 in the appendix shows a flow for the example, where ovals represent consumed and produced annotations, and boxes represent transformers.
   1. These flows may be oneshot or they may be repeating. Repeating flows are ones where outputs from a set of transformers feeds back into subsequent iterations, and where the result by change over subsequent iterations.
      1. Repeating flows terminate when a maximum repeat count is reached, or when no more changes occur.
8. Programs, which are sequences of Flows
   1. These programs maintain a knowledge of what annotations are modified by one flow, and these are given as changed inputs into the next flow. In this way, static analysis may reduce the number of transformations applied in any given flow.

### III. Shelf-PITA

Shelf-PITA is the application of PITA to the problem of making shelves.

PITA is mostly a set of transformers that perform parts of the operation of turning user desires about shelving into a representation of a shelving system.

### Concepts

### Solver

At the heart of the system is the Emu linear constraint solver. Bounds annotations are created in elements by transformers, and when all constraint work is completed, a Solver Update Transformer performs the work of adding new constraints to the solver and removing old ones. After this occurs, new state is extracted from the solver an assigned back into annotations. This process may repeat per repeating flows, above.

### Grammar

To provide an easy-to-use system for designers to produce furniture, restrictions on relationships between panels and other elements, and different stylistic elements are necessary. However, different furniture may require different restrictions and different stylistic elements. In order to accommodate this need for restrictions, but also the varying need for restrictions, Shelf-PITA implements a grammar system. In this system, a relationship between different elements is provided as a simple formal grammar.

An example grammar is included in the appendix.

### Grammar-Directed Edits

The grammar itself has two outlets for ambiguity.
1. Repeats may allow a certain grammatical element to repeat a number of times that is limited in both maximum and minimum, and which may stipulate a desirable initial state.
2. Variants may allow a grammatical element to stat that its child may be one of a certain set of possible children. For example, a specific empty space may either contain nothing, or it may contain a drawer.
   These avenues for ambiguity are also a set of possible edits that a user can make on a piece of furniture such as a shelf. So, user operations are either the switching of variants, or the increase or reduction in number of repeats of a repeating element.

### Stacks, StackRepeats, Voids, Panels, and Things: The Elements of Shelf-PITA

In this document we will refer to elements as five different types, although the properties of these categories are fluid and elements of one category can behave like another:
Things for the present are simply empty spaces in the model whose properties can be configured
Voids for the present are parents with a single child that may be switched among a set of possible children (a variant)
Stacks for the preset are parents that have zero or more children in a configuration specified by a grammar. For example, a stack may indicate it is a void followed by a panel.
Panels for the present represent pieces of wood with a thickness
StackRepeats are like stacks except they have a number of repeats which the user may modify, and potentially a head or tail, which is a continuation of the pattern at the beginning or end of the children.

### Constraints

Certain categories of constraints may be added to elements as annotations in different classes:
1. Constraints that are permanent and dictated by the grammar. For example, a panel's non-thickness dimensions may be no less than two inches each, to allow for manufacturability.
2. Constraints that happen when grammar elements are initialized, and are subsequently removed. For example, the initial width of this case is 24″.
3. “Stay” constraints, which are added in a flow that stabilizes the model and stop it from “snapping back” when temporary constraints are removed
4. “Oneshot” constraints that are used to express user wishes long enough to allow re-computation of the model and for stay constraints to lock new values into position
5. “Skeleton” constraints that represent layout constraints of the case (for example the adjacency of siblings within a Stack or a StackRepeat). These are typically “required” constraints. See below.
   Constraints exist at a specified priority level, such as the following.
1. Required
   1. This priority is used for required constraints. A system is unsolvable if no solution with no violated required constraints exists.
2. Physics
   1. This priority is used for constraints which, if violated, violate the laws of physics (for example the interpenetration of two panels is violated). Models are not manufacturable if any physics constraints is violated.
3. Lock
   1. This priority is used for constraints which the user has requested. For example, if the user stipulated the case width should be 24″ then a lock-priority constraint will exist (and be displayed to the user) that represents this.
4. Resting Boundary
   1. This priority is used to represent the resting weight of boundaries of a case. So, if a user edits a panel requesting a move outside the bounds of the case, the case will not resize to accommodate the request, because the resting boundary constraint is higher priority.
5. Edit High
   1. These three categories of constraint represent user edit priorities. For some operations, it can be the case that several desires are represented (for example, I want the bottom of this void to move, but under no circumstances should the top). These three priorities are used to articulate the user desire.
6. Edit Medium
7. Edit low
8. Resting
   1. This priority is used for variables in the solver after solution is complete. It stops elements from “snapping back” to previous values when user desires (one shot constraints) are removed from the system.

### Context Variables

In addition to variables being assigned for bounds, artificial variables, known as context variables, may be declared in the grammar of an item of furniture or cabinetry.

When constraints in the grammar reference these contextual variables, the lowest-enclosing instance of this context variable is used and referenced literally in constraints. So, for example, if we have a grammar system where there is a stack with two voids, and we wish for the second to be 3/2 the size of the first, we may have a grammar like:

```
s: {
  type: ‘stack’,
        contextVariable: ‘foo’,
        children: [‘v1’, ‘v2’],
}
v1: {
  ‘permanent-constraint-width’: [
    [
      { type: ‘:self’, axis: ‘lr’, side: ‘end’ },
      ‘−’
      { type: ‘:self’, axis: ‘lr’, side: ‘start’ },
    ],
    ‘=’,
    [new ContextVariableReference(‘foo’), ‘*’, 2] // note difference
  ],
},
v2: {
  ‘permanent-constraint-width’: [
    [
      { type: ‘:self’, axis: ‘lr’, side: ‘end’ },
      ‘−’
      { type: ‘:self’, axis: ‘lr’, side: ‘start’ },
    ],
    ‘=’,
    [new ContextVariableReference(‘foo’), ‘*’, 3] // note difference
  ],
}
```

### State Windows and State Window Functions

Various elements in a Shelf-PITA tree may be defined entirely or partially as state window functions, which take state from previous iterations and compute values from them. For example, the number of repeats in a stack may be a function of the size of a stack, allowing for automatic addition and removal of shelves.

However, as the set of compute state is large, without refinement, tiny modifications in output state would result in repeated total recomputations of all transformers that referenced computed state.

To provide for high performance, state window functions automatically declare what state they reference, and that referenced state is accumulated up the tree in a transformer. When transformers that can invoke state window functions run, they start by gathering all state from the previous solution, but then as they work their way down the tree, they discard all state that is not referenced by a state window function in that part of the tree.

In this way, transformers employing state window functions can “feed back” state from a prior solution into a subsequent solution without re-computing any functions whose values demonstrably could not have changed.
As a degenerate byproduct, the application of flows to Shelf-PITA trees with grammars defining no state window functions need not be repeatedly evaluated, as state window function evaluation is the sole method by which solution convergence can occur.

### 2D Sections

A section is a cut into a panel directed by some element of style. A section is defined against an element of a grammar, along with the degree and direction to which it is extruded, and how far the cut penetrates into the panel, and what shape represents the cut itself.

By allowing sections to be defined on one element but to affect a different element, the system allows complex cuts to be represented in terms that make sense to the designer (e.g. “I want a hole in this panel corresponding to the empty space on the right-hand-side of it”).

### Annotations in Shelf-PITA

BoundsExpressionAnnotation: represents a bound (axis+start|end) of an element of the tree in an expression that the solver can interpret. For example: {axis: Ir, side: end}⇒[‘mySolverVar1’, ‘+’, rational (3, 4)]
Bounds ValueAnnotation: represents a solves value for a bound. For example: {axis: lr, side: ‘end’}⇒rational (7, 4)
ChildNamesAnnotation: represents a set of all the names of children under a given element in the PITA tree. This is useful to narrow down searches for elements in large trees.
ComputedStyleAnnotation: represents the style in effect at a given node. Style elements include and are not limited to the operating axis in the case of stack elements (covered later), declared context variables (covered later), profile channels, operating sections, visibility of the element, thickness (for panels), selectability, opacity, display color, and initial and permanent constraints.
ContextVariablesAnnotation: Tracks what context variables are in-scope (see context variables, later).
ElementNameAnnotation: holds a unique name corresponding to this element.
GrammarNodeAnnotation: references the grammar node that was used to create this element. (see “grammar”, below).
PanelProfileAnnotation: stores the computed profile (shape) of a panel outline in addition to cuts made into the panel.
RelatedVariableGroupAnnotation: stores sets of variables that are connected together by simple required constraints
   A simple required constraint is one which has exactly two user variables and which is required. i.e. it represents a bijective mapping between the two variables.
   This is used to disable stay constraints when a new value for a variable is suggested
   In turn, this allows the user to modify the boundary of a case by dragging on its extreme elements, as these are related by simple required constraints to the boundary variables. See the description of the bounds expression assignment transformer and the skeleton constraint transformer.
ResolvedMovingExpressionAnnotation: this represents a set of variables that the user intends to “move” by suggesting new values. Used with RelatedVariableGroupAnnotation to effect boundary modification.
Section2DAnnotation: represents a desired “section” (see above, concepts)
SolverAnnotation: lives at the root of the tree and holds the present Emu solver for the system and also a “snapshot” of the tree the last time the system was solved.
   This snapshot is used to rapidly identify (via diffing) all constraints that have changed since the last solution
SolverVariable ValuesAnnotation: represents consequent state (rational numbers) from the solver after the last time the solver produced a solution.
StateWindowAnnotation: represents the sum total of state that all state window functions in the tree below this point reference.
StyleSheetsAnnotation: represents active style sheets in the tree. Grammar definitions can have style sheets attached which support a full set of CSS selectors and apply styles to given elements.

### Transformers in Shelf-PITA

These transformers are used in building Shelf-PITA
AddModel Transformer:
   Adds a model to the tree. This takes a grammar, instantiates it, and adds it to the tree. Other transformers turn this into finished product.
BoundExpressonAssignmentTransformer
   For each bound of an element, calculates an expression that represents it. For the end of an item of furniture, such as a shelf, in the normal axis of the shelf, this is the start plus the thickness, for example. For the start of a shelf in its normal axis, it's either its previous neighbor's end (if any) or it's parent's start bound (if not).
   Generally all bounds match their parent's (shrinkwrapping), but adjacent siblings are joined for stacks so that space is divided between them.
BoundValueComputation Transformer
   Evaluates bound expressions against a solved solver to compute rational bounds for variables.
ComputedStyle Transformer
   Evaluates PITACSS rules against elements and computes style for each element.
ConstraintResolutionTransformer
   When constraints are declared they're declared relative to containing element. This transformer determines the appropriate solver variable names corresponding to these element-relative descriptions and creates new constraints written in terms of solver variables.
DisableStaysForMovingVariablesTransformer
   This transformer creates new constraints where stay constraints corresponding to related variable groups where one variable is a moving variables are disabled.
InstanceContext VariableTransformer
   This transformer adds records representing context variables (including unique solver variables names).
Model Constraints Transformer
   Extracts constraint declarations from a grammar and puts them into constraints annotations in elements. Part of element construction.
NameAssignmentTransformer
   Gives elements unique names.
OneShotRemoverTransformer
   Strips the tree of all oneshot constraints
PanelProfileTransformer
   Evaluates the set of extant sections for ones intersecting a given element, and uses two-dimensional constructive solid geometry to calculate panel profiles. These are used in display to the user and also in compilation, described later.
RelatedVariableRollupTransformer
   Computes sets of variables that are transitively connected by simple required constraints
RemoveModel Transformer
   Used to remove a model from the Shelf-PITA tree.
Remove Transformer
   Removes an element from a StackRepeat
RepeatEnforcementTransformer
   Guarantees that a stack repeat's current size is compatible with the maximum and minimum for that stack repeat, as well as the state window function that describes the current repeats
ReqConstraintsRel VariablesTransformer
   Adds related variable groups for required constraints from the permanent and skeleton categories.
Section2DTransformer
   Computes sections based on section state window functions, and stores the computed section into the section2dannotation.
SolverUpdate Transformer
   Updates the solver in this way
      Takes the diff of the last-solved tree and the present tree. Calculates entering, and exiting constraints
      Proceeds by
         1. Adding entering-non-required
         2. Removing exiting required
         3. Adding entering required
         4. Removing exiting non-required
   This ordering is important. It allows new constraints to coexist with old maximally, which avoids intermediate states where solutions get anchored undesirably.
StateWindowExtraction Transformer
   Computes the required state windows for elements in the tree, and rolls the up (unions the state window) up the tree to the root.
   A corresponding class, StateProjection tracks all the consequent solver state that a transformer will propagate down the tree.

### Mutators

Mutators modify a single element in the tree. Most user actions are defined as mutators. Typically the pattern is that the mutator makes a slight modification to a part of the tree, and the PITAProgram (described above) is run to turn the tree into a final form.
AlignMutator
   Adds a oneshot constraint that sets equal two bounds expressions
InsertMutator
   Inserts as a child of an element extra elements that represent an additional repeat of a StackRepeat
LockUnlockMutator
   Adds an element to the lock constraint group that represents a user desire that certain measurement not change
MoveMutator
   Adds a oneshot constraint stipulating a specific value for a variable in the system
SuggestMeasureMutator
   Adds a oneshot constraint stipulating a specific value for the difference between the end and start expressions for a certain axis on an element, or for the difference of starts and ends between two elements.

### The Scene

The scene is a container for the Shelf-PITA tree. It includes a dispatch function which takes a SceneVerb and applies it to the present scene, returning a new scene.

### Scene Verb

Scene Verbs represent user actions in the system. For example:

```
s: { type: ‘stack’, contextVariable: ‘foo’, children: [‘v1’, ‘v2’], } v1: { ‘permanent-constraint-width’: [ [
{ type: ‘:self’, axis: ‘lr’, side: ‘end’ }, ‘−’ { type: ‘:self’, axis: ‘lr’, side: ‘start’ }, ], ‘=’, [new
ContextVariableReference(‘foo’), ‘’, 2] // note difference ], }, v2: { ‘permanent-constraint-width’: [ [
{ type: ‘:self’, axis: ‘lr’, side: ‘end’ }, ‘−’ { type: ‘:self’, axis: ‘lr’, side: ‘start’ }, ], ‘=’, [new
ContextVariableReference(‘foo’), ‘’, 3] // note difference ], }
/**
  * ADDMODEL
  */
export type AddModelVerb = {
  verb: ‘v2/addModel’,
  model: ModelName,
};
```

These are simple descriptions of modifications the user wishes to effect.

### Reducer and History

The platform's user interface is implemented on top of a reducer. The reducer state has an attached history. When a user action is dispatched in the reducer,
1. A function is added to the history that turns the previous history into the next history.

The reducer provides access to the tip of the history. When this is accessed, the history is asked for its most recent element. If this is cached it is returned. If it is not, it looks for its previous history entry and applies the most recent edit, caching and returning the result.

This process of course applies recursively until the base state is reached. In this way the history tracks a history of edits.
When the reducer dispatches an “undo”, an “undo” record is added to the history. When evaluating “most recent”, the history interprets undo as meaning not “apply the most recent edit to the previous state”, but instead as “the previous state of the previous state”.
Likewise, redo is interpreted in the interpretation of edits as countermanding the most recent redo.
These may stack.
The main point here is that nothing is ever removed from the history, just edited. This is important for concurrent access. See below.

### The Session

Every edit in the system has an attached session identifier. Typically when a user arrives at a website that provides access to various embodiments of the platform, they're assigned a session, and edits occur under this session. When a user makes an edit, that edit is tagged with a monotonically increasing logical clock number representing the edit, along with a session ID. Collectively these comprise a “session time”, which describes the nth action that occurred within the specified session.

### Concept Time

New furniture and/or cabinetry editing sessions are stored in a database in the cloud. They are stored as a sequence of edit actions. When an edit action exists in the database, it is given a “concept time” which represents a total ordering of edit actions that exist within the database. Replaying all edit actions ordered by concept time yields a Shelf-PITA tree representing the new furniture/cabinetry.

### The History Syncer

The history syncer polls the reducer to ask if there are any history items that are not present in the database. Items without a concept time are not in the database.

It then takes any edits that have not been synced and sends them by RPC to the cloud server, which assigns concept times to any new items (determined by session time), stores the edits in the database, and returns the new concept times to the user, along with any edits that have arrived (and been assigned concept times) from other concurrent users.
The history syncer takes this response and feeds it back into the reducer as an “updateTimes” dispatch. This is provided to the history, which interleaves any new edits into the existing streams, shoots down any invalidated cache entries, etc.
At this point, with a new reducer state, React (the UI framework) re-renders the new furniture, such as a shelf, which may involve re-playing edit actions to create a new shelf state.
In this way, the various embodiments provide for collaborative shelf design across the internet and various other types of networks.

### User Interface

The platform provides a website where, using the above, users can create new furniture, e.g., shelves. The users can edit and measure the new furniture and add it a shopping carts. An order for manufacture and delivery of the new furniture may be performed using one or more of payment and/or financing software applications. One or more embodiments of the website may be a react-three-fiber editor with edit controls that appear and disappear dynamically based on the state of a selection. Selectable elements inside the user interface include panels, voids (empty spaces in the case) and measures. Generally, any user action that is applied with an active selection is applied to all elements inside the selection. For example, if two panels are selected and then moved, new one shot constraints are added that represent the movement of all of the selected shelves.

### Incentives

The various embodiments of the platform incentivize growth in one or more of the following ways:
1. When a user signs up, they get a certain number of referral codes in their wallet.
2. When a user refers another user, and that user signs up they get a $10 credit for shelves.
3. When a user refers another user, the first time that user buys shelves, the referrer gets a % of the transaction as a credit for future shelves.

### Visualizing Install

The various embodiments of the platform may implement a mode, using compilation, below, that shows/animates every step of the assembly process including what assemblies connect, and which direction they slide together in. It may have a back button, a forward butting, and a range control that allows the user to move between assembly steps. In this way, the users may pan, scroll, and zoom just as with editing to see each assembly step.

### Compilation

Once a new furniture design is complete, it may be necessary to determine how to turn the new furniture design into a set of instructions for a Computer Numerical Control (CNC) router. The various embodiments of the Platform may provide a join system generates a slide tenon and mortise design that may be cut entirely with CNC machines for various types of a solid material including, veneer plywood, plywood, solid wood, particle board wood, metal, plastic, stone, polymers, composite materials, and the like.

Alternatively, the various embodiments of the Platform may be employed to manufacture pouring molds for new designs of components for furniture/cabinetry or structural elements, e.g., counters, sinks, showers, bathtubs, walls, ramps, floors. The pouring molds may be used with various types of materials associated with a state change from a liquid to a solid at ambient temperatures, such as concrete, metal, plastic, ceramics, polymers, composite materials, and the like.

### Structure of Tenon

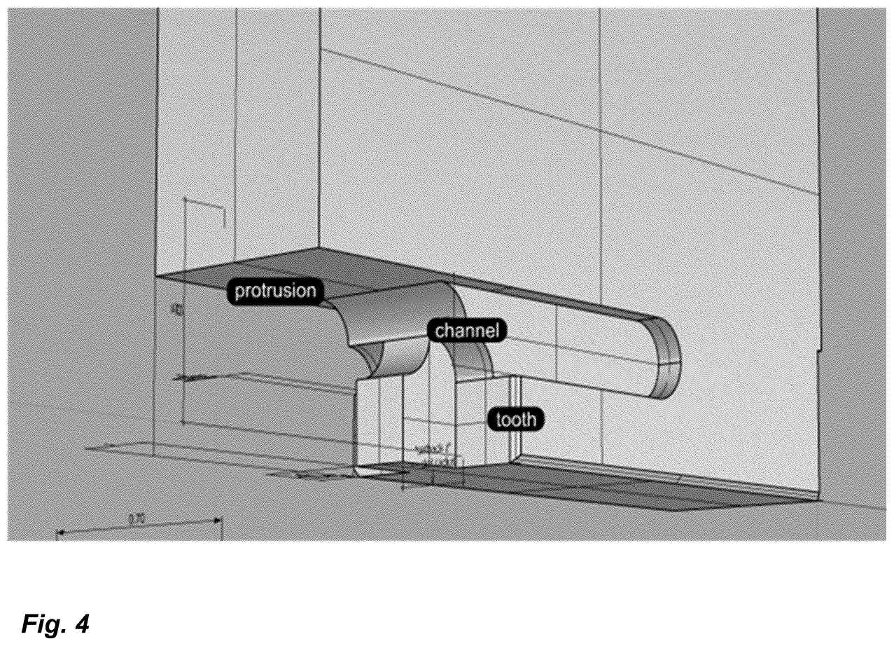

FIG. 4 illustrates a three-dimensional schematic view of a tenon that is complementary to a mortise for a piece of solid material. A tenon consists of various parts cut by different Computer Numerical Control (CNC) machine tools.
The tooth refers to a piece of solid material that holds the tenon into the mortise
The channel is a cut of in the solid material that the mortise locks into
An active registration component (depicted in the near end of the depiction above) that ensures that the tenon enters no further than desired into the mortise

### Structure of Mortise

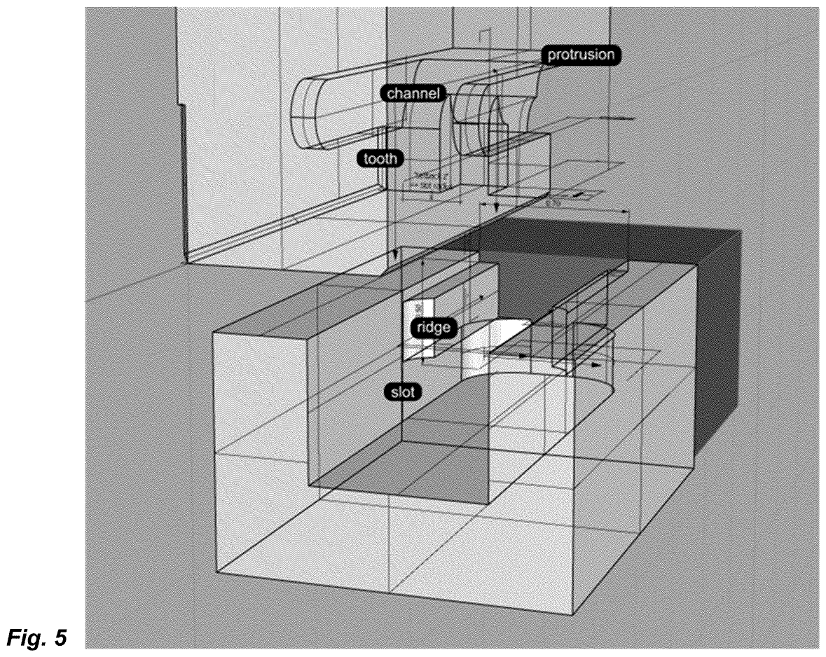

FIG. 5 illustrates a three-dimensional schematic view of a mortise that is complementary to a tenon. The mortise is a complementary part to the tenon. The tenon enters into a hole, and then pushes (away in the diagram) into a slot (tooth enters slot) and the active registration hits the back side of the slot. Meanwhile, the ridge enters the channel, creating an active lock in both directions. Typically these pieces are glued together, but the system also works without glue. Notably, no hardware is required in this system.

### Join and Tenon Assignment

Given a completed design, it's necessary to determine where to allocate mortises and tenons on panels to allow for joining. Here again the platform uses a hierarchical tree. The normal of a panel is the vector emerging out from a face of a panel, i.e. in the direction of the thickness. For panels, we say two panels are compatible if the dot product of their normals is zero, where they are non-overlapping, and where the end of one panel on a non-normal axis abut another panel on the normal axis.

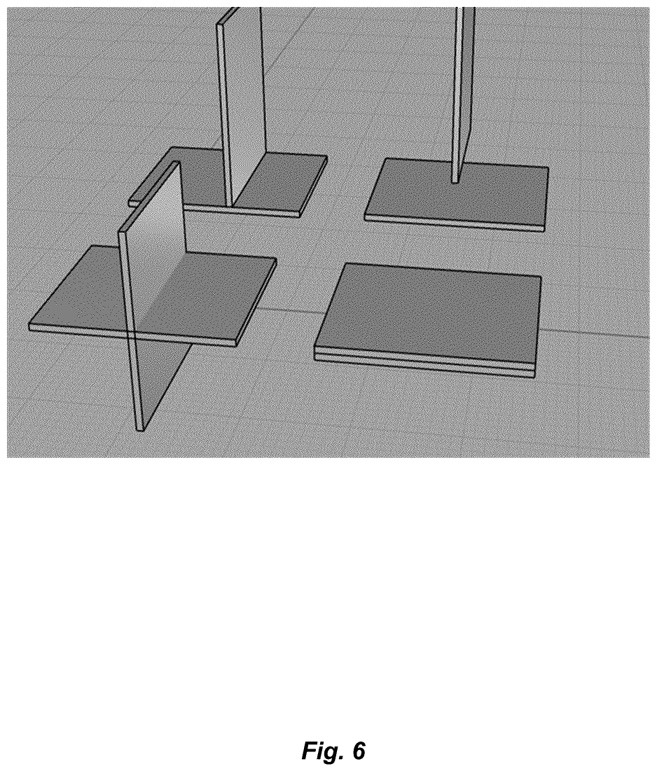

FIG. 6 shows an exemplary three-dimensional view of four different ways to join two panels to enable determination of an optimal allocation of tenons and mortises to facilitate easy joining of the two panels. The view includes four quadrants. Top left: compatible (abutting, non-overlapping, non-normal vs. normal). Top right: incompatible (non-abutting). Bottom left: incompatible (interpenetrating). Bottom right: incompatible (normal vs. normal).

An assembly is defined as a group of panels that have already been joined. For an element within the tree with zero children, the assembly of that element is just the element, if the element is a panel, or else nothing at all. For an element with a single child, the assembly for that element is the assembly of the child (this assumes that panels have no children). For an element with multiple children, we get the assembly for each child, and then pairwise for adjacent children we attempt to see if there are panels in the assembly for each assembly that are compatible with each other. If we find that two adjacent assemblies are compatible across one or more panel pairs, we choose the axis with the best (most) join opportunities and create an assembly that joins these two sub-assemblies. In this way, all panels in the structure are assembled back towards the root of the tree. To prepare assembly steps for the case, we visit the assembly tree depth-first. Each node in the tree in depth-first order represents a step in assembly.

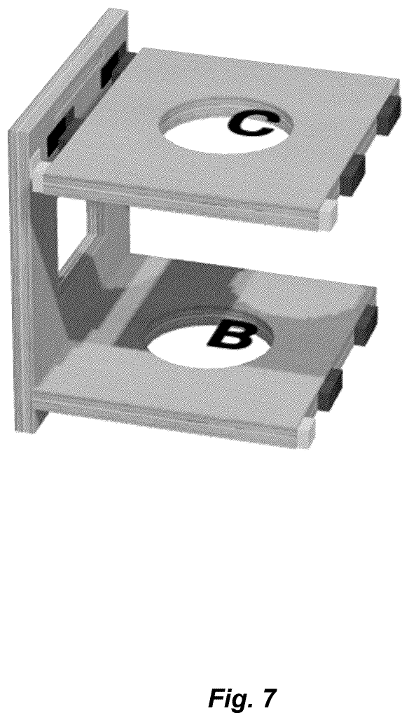

Additionally, FIG. 7 illustrates an exemplary three-dimensional visualization mode for the joining steps of panels presented to the user in a user interface.

For employing one or more of the embodiments, several aspects of various systems and methods are summarized below.

### 1. System for Constraint-Based Design

A system for designing customizable shelving systems, comprising:
A grammar engine configured to define a set of rules governing the relationships and configurations of design elements, wherein the grammar includes support for repeating and non-repeating elements;
A linear constraint solver configured to apply constraints to design elements, ensuring compliance with structural, aesthetic, and user-defined requirements, the solver utilizing rational arithmetic for precision;
A hierarchical tree structure representing the design, wherein each node in the tree corresponds to a design element and includes:
Annotations that track properties, constraints, and contextual variables; and
Logical clocks for tracking modification times of annotations and elements;
A transformation engine configured to apply idempotent transformations to the tree structure, consuming and producing annotations while maintaining minimal modification principles; and
A rendering module configured to generate a visual representation of the design and its transformations.

### 2. Method for Real-Time Collaborative Design

A method for collaborative design of shelving systems, comprising:
Receiving user input defining modifications to a design represented as a hierarchical tree structure;
Applying a sequence of idempotent transformations to the tree, based on a defined set of flows, to propagate the modifications throughout the structure;
Resolving constraints using a linear constraint solver configured to handle rational arithmetic and lexicographic priorities;
Tracking and synchronizing edits across multiple users via a session-based history system, wherein edits are ordered by a concept time; and
Rendering a shared, updated design in real-time to all users.

### 3. Constraint Solver for Modular Furniture Design

A constraint-solving system for modular furniture design, comprising:
A solver implemented as an immutable data structure capable of:
Adding and removing constraints dynamically;
Maintaining priorities among constraints using lexicographic weights; and
Detecting and reporting overflow conditions;
An interface for associating solver variables with elements of a design grammar, enabling contextual constraint resolution across hierarchical structures; and
A mechanism for extracting solved variable states and applying them to annotations within a hierarchical design tree.

### 4. Dynamic Grammar System for Furniture Design

A grammar system for customizable furniture design, comprising:
A formal grammar defining relationships among elements, including rules for repeating elements and variant elements;
A mechanism for dynamically instantiating grammar nodes as design elements in a hierarchical tree structure;
Support for context variables, wherein constraints can reference variables defined at higher levels of the grammar hierarchy; and
A transformation engine for enforcing grammar rules and propagating constraints throughout the design.

### 5. Optimized State Management for Design Transformations

A system for optimizing state management in hierarchical tree transformations, comprising:
State window functions for defining dependencies between annotations and prior transformation states;
A mechanism for accumulating referenced state along the tree structure while discarding unreferenced state;
A repeating flow system configured to iteratively apply transformations until convergence or a maximum iteration count is reached; and
A caching mechanism for pruning sections of the tree that remain unchanged between iterations.

### Dependent Elements

1. The system of claim 1, wherein the grammar engine supports user-defined constraints and style preferences.
2. The system of claim 1, wherein the annotations include computed styles derived from CSS-like rules.
3. The method of claim 2, further comprising a visualization module that animates the assembly of the designed shelving system step-by-step.
4. The constraint-solving system of claim 3, wherein the solver supports lexicographic priorities corresponding to categories of constraints, including required, user-defined, and temporary constraints.
5. The grammar system of claim 4, wherein the rules support automatic adjustment of element dimensions based on design constraints.
6. The optimized state management system of claim 5, wherein repeated transformations terminate when no further changes to state windows are detected.

### Joinery

### 1. System for Joinery in Modular Furniture

A joinery system for connecting panels in modular furniture, comprising:
A tenon configured to be inserted into a mortise, the tenon including:
A tooth for engaging a slot within the mortise to secure the connection in one direction;
A channel for receiving a ridge on the mortise, creating an active lock in a second direction;
An active registration component to limit the insertion depth of the tenon into the mortise; and
A mortise configured to receive the tenon, the mortise including:
A slot for receiving the tooth of the tenon;
A ridge configured to engage the channel of the tenon;
A complementary registration surface for engaging the active registration component of the tenon to ensure precise alignment;
Wherein the system requires no additional hardware and is adapted for manufacturing with Computer Numerical Control (CNC) routers.

### 2. Computer Numerical Control (CNC) Compatible Joinery System

A joinery system for use in furniture design, comprising:
A tenon formed from a solid material, the tenon including:
A tooth for securing the tenon within a slot of a mortise;
A channel for engaging a ridge of the mortise to lock movement orthogonally to the tooth's engagement;
A registration mechanism to prevent over-insertion of the tenon into the mortise; and
A mortise formed from a solid material, the mortise including:
A slot for receiving the tooth of the tenon;
A ridge for engaging the channel of the tenon;
A registration stop for limiting tenon insertion;
Wherein the joinery is designed to enable precision cutting using a CNC router without requiring additional hardware.

### 3. Glue-Optional Joinery System

A system for joining panels in modular shelving or furniture, comprising:
A tenon including:
A tooth and channel configured for mechanical locking with a corresponding slot and ridge of a mortise; and
An active registration component ensuring precise depth alignment;
A mortise including:
A slot for receiving the tenon tooth;
A ridge for interlocking with the tenon channel; and
An interlocking mechanism enabling secure connection without the use of glue or hardware, wherein the system is Computer Numerical Control (CNC) compatible and designed for assembly using a solid material.

### Dependent Elements

1. The system of claim 1, wherein the tenon and mortise are manufactured entirely from a solid material.
2. The system of claim 1, wherein the tenon and mortise are designed to allow repeatable disassembly and reassembly without damage.
3. The system of claim 2, wherein the tooth and slot include tapered edges to facilitate easy insertion and removal.
4. The system of claim 1, wherein the active registration component is a protrusion on the tenon designed to contact a flat registration surface in the mortise.
5. The system of claim 3, wherein the ridge and channel are dimensioned to provide frictional resistance to prevent unintended disengagement.
6. The system of claim 1, wherein the tenon and mortise are designed to self-align during insertion, ensuring flush panel connections.

### Join Assignment

### 1. System for Automated Join Assignment in Modular Designs

A system for assigning mortises and tenons in modular furniture designs, comprising:
A hierarchical tree structure representing the design, where each node corresponds to an element or subassembly;
A compatibility determination module configured to:
Identify panels as compatible if the dot product of their normals is zero, their non-normal axes abut, and they do not overlap or interpenetrate;
An assembly generation module configured to:
Traverse the tree to identify subassemblies for each node;
Merge adjacent subassemblies based on the maximum number of compatible joins between their panels;
Create a new assembly by assigning mortises and tenons to the compatible panels;
A step generation module configured to traverse the assembly tree in depth-first order to generate sequential assembly instructions.

### 2. Method for Join Assignment in Furniture Design

A method for assigning joins in modular furniture designs, comprising:
Representing the design as a hierarchical tree structure;
Determining compatibility between panels based on:
The dot product of their normals being zero;
Abutment along a non-normal axis to a normal axis; and
Absence of overlapping or interpenetration;
For each node in the tree, recursively:
Identifying subassemblies corresponding to its child nodes;
Pairing adjacent subassemblies and selecting the axis with the highest number of compatible joins;
Creating a new assembly by assigning mortises and tenons to compatible panels;
Generating sequential assembly steps by traversing the resulting assembly tree in depth-first order.

### 3. System for Hierarchical Assembly of Modular Panels

A system for determining join assignments and generating assembly steps for modular panel-based designs, comprising:
A tree structure representing the design hierarchy;
A compatibility evaluator configured to identify compatible panel pairs based on geometric relationships, including:
Normal vectors of panels, where compatibility is determined by a dot product of zero;
Abutment along non-normal and normal axes;
Exclusion of overlapping or interpenetrating panels;
A subassembly merger configured to:
Traverse the tree and recursively merge subassemblies based on compatibility across panel pairs;
Assign mortises and tenons to create secure joins between panels;
An assembly sequencing module configured to:
Traverse the resulting assembly tree in depth-first order;
Generate step-by-step instructions for assembling the panels.

### Dependent Elements

1. The system of claim 1, wherein compatibility is further determined by evaluating user-defined tolerances for abutment distances.
2. The system of claim 1, wherein assemblies are prioritized based on structural stability, with panels joined along axes that maximize overall rigidity.
3. The method of claim 2, further comprising the step of assigning join priorities to panels based on their position within the tree hierarchy.
4. The system of claim 3, wherein the assembly tree is augmented with metadata describing the type of join assigned to each compatible pair of panels.
5. The method of claim 2, wherein the generated assembly sequence includes visual instructions for each step, representing panel orientation and join alignment.
6. The system of claim 1, wherein the tree traversal accounts for dynamic user modifications to the design, updating join assignments and assembly steps in real-time.
7. The method of claim 2, wherein the assembly generation process includes simulating physical constraints to validate join feasibility.

### Illustrative Logical System Architecture

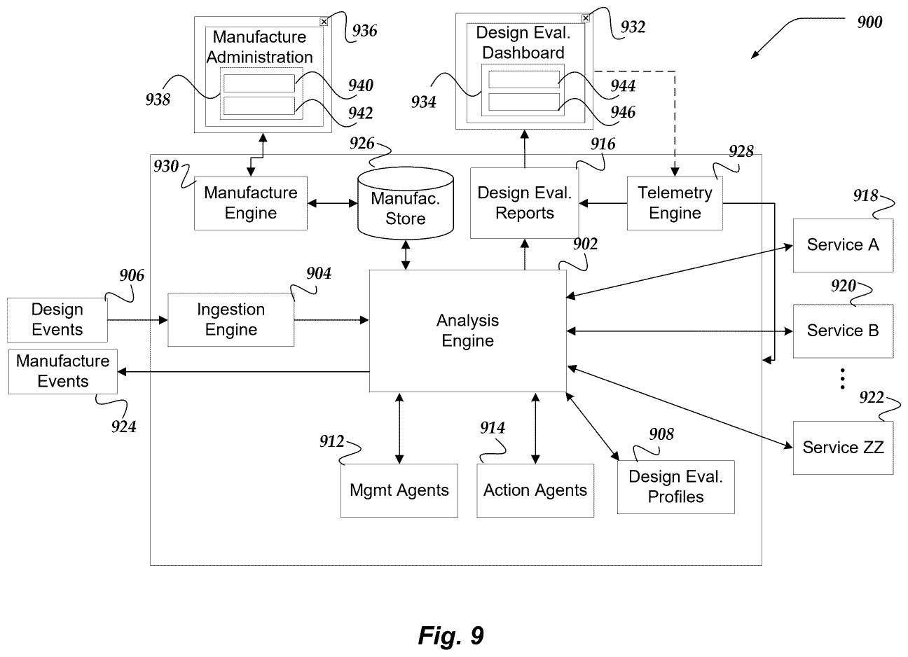

FIG. 9 illustrates a logical architecture of system 900 for automated evaluation of a design job for furniture based on real time design information provided by a customer and analysis of the resources and costs associated with manufacture of the furniture in accordance with one or more of the various embodiments.

In one or more of the various embodiments, design analysis engines, such as design analysis engine 402 may be used to analyze one or more design events 406 that may be associated with the collection of information that may be used for designing furniture or evaluating the manufacturing job, such as cost, recommended and/or selected materials, or the like. In some embodiments, design events may be collected from a customer by ingestion engines, such as inspection engine 904. Ingestion engines may be arranged to pass design events to analysis engine 902 for further analysis.

Also, in some embodiments, manufacture engine 930 may be arranged to collect or manage the manufacturing plans for the designed furniture. In some embodiments, manufacturing plans may include rules or instructions for performing various design related activities, including cost estimates, completion inspections, assembly instructions, customer task instructions, or the like. In some embodiments, manufacturing plans may be included in database tables, structured documents, non-structured documents, computer numerical control (CNC) machine instructions, or the like. In some embodiments, manufacturing plans may be stored for reuse in a data store such as manufacture plans store 926.

In some embodiments, analysis engines, such as analysis engine 902 may be arranged to execute one or more manufacture plans. Accordingly, in some embodiments, analysis engines may determine one or more manufacture instructions, such as manufacture events 924 which may be communicated to a remotely located technician and a manufacture machine, e.g., a CNC machine, a three dimensional (3D) printer machine, or the like.

The manufacture events may guide or direct the technician to perform various actions such as selecting one or more types of material, such as veneer plywood, plastic, particle board, solid wood, metal, composite materials, 3D printer filament, or the like. The sheets of material are provided to the manufacture machine to create a plurality of components that can be assembled into the custom designed furniture. In one or more embodiments, as the technician performs the guided actions and the manufacture machine creates the components from the materials, the associated manufacture events may be collected and communicated to analysis engine 902.

The manufacture events may also upload customized instructions to the manufacture machine to automatically create the custom shapes and custom joins for each of the components that are subsequently used by the customer to assemble the custom designed furniture. In one or more embodiments, the forming and manufacture of the custom joins may be based on one or more of a size, a weight, a material, a shape or a clearance for each sub-component of the custom designed furniture. In one or more embodiments, the custom joins may be specifically created/manufactured as compression joins, such as mortise and tenon, so that a customer may assemble the sub-components together into the custom designed furniture without the use of specialized tools, mechanical fasteners or adhesives. Further, in one or more embodiments, the custom joins may optionally be created as a combination of both compression joins and non-compression joins, which do require mechanical fasteners and/or adhesive for non-compression joining of some or all of the components together into an assembly for the custom furniture designed by the customer.

In one or more embodiments, as the design events are received by the analysis engine, it may evaluate the incoming design events in view of previously obtained design events and the current manufacture instruction to determine a next manufacture instruction. In some embodiments, analysis engines may be arranged to continue to send manufacture instructions and receive design events until it determines that the manufacture of the custom design furniture may be completed.

In one or more embodiments, analysis engine 902 may be arranged to generate one or more design evaluation profiles 908 that may be provided to one or more of the evaluation services for further information related to executing the manufacture of the furniture. In some embodiments, design evaluation profiles may be formatted or configured to appear or operate as one or more result of manufacture instructions. Accordingly, in some embodiments, analysis engines may submit design evaluation profiles to one or more evaluation services or agents. Thus, in some embodiments, evaluation services or agents (besides or otherwise not limited analysis engines) may consume the manufacture and design information and process it. In the case of analysis engines, design evaluation profiles may initiate automated further investigations by dynamically updating the manufacturing instructions with one or more new manufacturing instructions.

In some embodiments, analysis engines may be arranged to format design evaluation profiles to match the requirements of the receiver of the profile. Accordingly, in some embodiments, analysis engine may be configured to apply design evaluation transformers to format design evaluation profiles to conform to one or more registered targets, including evaluation services, agents, or other analysis engines. In some embodiments, design evaluation transformers may be considered to be data structures that include the instructions that may be executed to generate properly formatted messages for particular targets. In some embodiments, analysis engines may be configured to communicate design evaluation profiles to more than one target. Accordingly, in some embodiments, analysis engines may be arranged to employ more than one design evaluation transformer.

In some embodiments, analysis engines may be arranged to determine manufacture instructions from the design instructions. In some cases, manufacture instructions may include machine readable lists of instructions, such as CNC instructions, that may provide a recipe of how to perform a manufacture job for one or more components of the custom designed furniture. Also, in some embodiments, analysis engines may be arranged to provide manufacture instructions to management agents, such as management agent 912 to enable the agent to evaluate the manufacture instruction and determine the next manufacture instructions. Further, in some embodiments, as manufacture events may be collected as the manufacturing is performed, they may be provided to the management agents to enable the incoming manufacture events to be considered while selecting the next manufacture instruction.

Also, in some embodiments, analysis engines may create generative AI prompts that include the manufacture instructions, collected manufacture events, or other information that may be provided to management agents. Accordingly, in some embodiments, the management agents may submit the prompt to generative AI models that may recommend a next manufacture instruction, if any. Further, in one or more embodiments, the Model Context Protocol (MCP) or the like, may be employed by one or more types of agents to access information for use with one or more generative AI models.

In some cases, for some embodiments, a job may require specialized analysis for determining the next manufacture instruction or otherwise evaluating the manufacturing performance. Accordingly, in some embodiments, analysis engines may be arranged to selectively employ action agents that may be specialized for particular manufacture job types or manufacture job tasks, These agents may include specialized instructions, heuristics, prompts, or the like that may be directed to one or more specialized tasks.

In some embodiments, analysis engines may be arranged to communicated with one or more external services, such as service 918, service 920, or service 922 to obtain additional information or analysis to support the execution of manufacturing instructions and/or a plan. For example, in some embodiments, if the analysis engine determines that a technician may be required to review a manufacture event or confirm a manufacture instruction, the analysis engine may be configured to reach out to communication service (e.g., service 918 or the like) to provide the enhanced review. Similarly, in some embodiments, an external service may include a real-time pricing service, or material inventory service, or the like for collecting real-time information to support pending manufacturing for furniture that is custom designed by the customer.

In some embodiments, analysis engines may be arranged to track the history or performance of various manufacturing instructions, manufacturing plans, specialized agents, prompts, or the like to enable various meta-evaluations that may be used to evaluate their performance. Accordingly, in some embodiments, analysis engines may collect and maintain manufacture evaluation profiles that may characterize the performance of the manufacturing plans, specialized agents, prompts, manufacturing instructions, or the like.

Also, in some embodiments, analysis engines may be arranged to associate, determine, or collect various scores, such as severity scores, weight scores, priority scores, risk-scores, or the like for collected manufacturing information. In some cases, analysis engines may be arranged to generate prompts or enhance prompts that may be used by one or more agents for conducting some or all of the analysis operations.

In some embodiments, analysis engines may be arranged to employ one or more management agents, such as, management agents 912 to begin or manage the operations executed to classify events. In some embodiments, management agents may work with one or more action agents, such as action agents 914. In some embodiments, action agents may be arranged to perform one or more particular tasks as part of evaluating design events and/or manufacture events.

In some embodiments, management agents or action agents may be arranged to direct analysis engines to access various internal services or external services to analyze collected design and manufacture information. In this example, for some embodiments, service 918, service 920, or service 922 may be considered to represent one or more internal services or external services that may be employed to contribute to the analysis of collected design and manufacture information.

For example, in some embodiments, an action agent may direct the analysis engine to use an external service to calculate quantitative metrics with overlapping cost calculations based in part on the collected manufacture information associated with custom furniture designed by the customer. Further, in one or more embodiments, an action agent may direct the analysis engine to use an external service to estimate the remaining life of an existing roof with adjustments based on severity of roof damage. Also, in some exemplary embodiments, an action agent may direct the analysis engine to use an external service to obtain estimated costs. Further, in one or more embodiments, an action agent may direct the analysis engine to use an external service to generate one or more design evaluation reports in a format that is suitable for display to the customer. And in some embodiments, an action agent may direct the analysis engine to use an external service to obtain a design evaluation report that includes one or more images and/or videos that are arranged to support one or more design or manufacturing recommendations. Also, the design evaluation report may include one or more visualizations that animate the assembly of the custom designed furniture by the customer.

Accordingly, for some embodiments, an action agent may generate instructions that include one or more Application Programming Interface (API) calls to internal or external services to provide supplemental evaluations for information classification. Also, in some embodiments, one or more action agents may be arranged to execute APIs of internal services or external services direct from within the agent rather than relying on the analysis engine to execute the API calls.

In one or more of the various embodiments, if design and/or manufacture information has been classified, analysis engines may be arranged to generate one or more reports, such as design evaluation reports 916. In some embodiments, these reports may be considered machine-readable information that other reporting tools or reporting services may employ to generate reports, visualizations, interactive reports, or the like. Also, in some embodiments, ingestion engines, manufacture engines, analysis engines, or the like may be arranged to generate one or more user interfaces that enable interactive reports to be presented using data or other information included in design evaluation reports 916.

In some embodiments, manufacture events may include directives to generously collect manufacture information or potential manufacture information from a broad set of manufacture reference sources. Accordingly, in some embodiments, potential manufacture plans may be stored temporarily or archived persistently in manufacture data store 926. Also, previously created manufacture plans or new manufacture plans created for a new design of furniture, may be stored temporarily or archived persistently in manufacture store 926. In some embodiments, manufacture store 926 may be used to temporarily store working copies of potential manufacture information as it may be reviewed for relevance.

In some embodiments, manufacture engine 930 may be arranged to use one or more design events and/or manufacture events to orchestrate automated manufacture information collection. In some embodiments, design events and/or manufacture events may be data structures that store or reference instructions, rules, libraries, or the like used for declaring one or more particular design/manufacture information collection actions. In some embodiments, design events and/or manufacture events may be associated with particular types of custom designed furniture. Also, in some embodiments, design events and/or manufacture events may be associated with potential or existing customers or particular types of customers, e.g., residential, commercial or industrial customers.

In general, one of ordinary skill in the art will appreciate that manufacture engines may be arranged to score various design events and manufacture events based on various metrics, including age, number of times used, direct user feedback (e.g., scoring), quality of results, profitability, or the like.

Further, in some embodiments, systems, such as system 900 may include one or more telemetry engines, such as telemetry engine 928. In some embodiments, telemetry engines may be arranged to monitor or evaluate interactions with applications or user interfaces such as user interface 932, user interface 936, or the like. In some embodiments, this may include monitoring how users or even other applications may interact with user interfaces, interactive reports (e.g., design evaluation reports), various applications, or one or more system features.

In some embodiments, user interfaces, such as user interface 932 or user interface 936 may include various windows, controls, or other user interface features. In some embodiments, user interfaces may include various user interface panels, such as panel 938, panel 934, or the like. In some embodiments, panel 938, or the like may represent a user interface that enables users, such as manufacture administrators, to review manufacture performance information or manufacture administration information. In some embodiments, element 940, element 942, element 944, element 946, or the like may be considered to represent various user interface elements, controls, buttons, list items, report features, user interface components, displayed content, formatted content, or the like that may be included in user interfaces.

In some embodiments, user interface 936 may be considered a user interface that enables administrative users to work with manufacture plans, report formatting, manufacture performance information or manufacture administration information, or the like. In some embodiments, panel 938 may be used to select, generate, or modify manufacture plans, manufacture instructions, manufacture profiles, or the like. In some embodiments, display panel 938 may be used to display quality or effectiveness rankings for one or more manufacture plans or manufacture instructions sorted based on inferred importance, value, or the like. In some embodiments, panels such as panel 938 may be used to display manufacture plans, manufacture instructions, manufacture profiles, or display reports regarding manufacture plans or manufacture instructions and their relevance or performance with respect to different manufacturing jobs, furniture types, or the like.

In some embodiments, user interface 932 may be considered a user interface that enables customers/users to create and specific designs in real time for one or more items of custom furniture. User interface 932 may be arranged for a customer to select and/or design a plurality of elements for the furniture, including one or more of a type of furniture, a material for manufacture, physical dimensions of the furniture, material finishes, shapes of various components of the furniture, and/or join types, or the like. In one or more embodiments, display panel 934 of user interface may also be arranged to enable the customer to review recommendations for the design provided by the analysis engine. Further, in one or more embodiments, display panel 934 may be arranged to display one or more design evaluation reports that may include a cost estimate, proposed manufacture schedule, preview of the custom design, visualizations for step by step assembly of the custom design, and recommendations related to the custom design, proposed manufacture and delivery schedules and cost estimate.

In one or more embodiments, the consumer may employ user interface 932 to provide dimensional information and/or images of a potential physical location or type of environment where the custom designed furniture will be used. Also, the consumer may provide dimensional, weight, and other relevant information and/or images of a physical object that may be supported by and/or enclosed within the custom designed furniture.

In some embodiments, analysis engines, such as analysis engine 902 (as well as manufacture engines, telemetry engines, or the like) may be arranged to generate or display user interfaces, such as user interfaces 936 or 938 to users using one or more of video interface 242, projector 246, display 250, or the like, of a client computer, such as client computer 200 discussed in FIG. 2. In some embodiments, analysis engine 902, or the like may be arranged to generate or display user interface 932, user interface 936, or the like to users using a one or more of input/output interface 338, display 350, audio interface 356, or the like, of network computer 300 discussed in FIG. 3.

In some embodiments, analysis engines, such as analysis engine 902 (as well as manufacture engines, telemetry engines, or the like) may be arranged to collect various telemetry or other metrics associated with user interactions with user interfaces. In some embodiments, telemetry may include tracking or monitoring if customers and administrators may be in agreement with manufacture plans, manufacture instructions, manufacture scheduling, report contents, report arrangement/organization, or the like. In some embodiments, analysis engines, or the like may be enabled to employ telemetry information or telemetry metrics collected or determined by telemetry engines, such as telemetry engine 928. In some embodiments, telemetry engines may be separate from analysis engines, manufacture engines, or the like as shown in FIG. 9. In some embodiments, telemetry engines may be part of or otherwise embedded in analysis engines, manufacture engines, or the like.

In one or more embodiments, various types of collected user telemetry may include a user's selection or non-selection of one or more particular elements or content in a display panel, pointing device (mouse) hover time over particular content or elements in a display panel, user dwell time between actions in a display panel, dwell time for viewing a display panel by a user, and the like.

In one or more of the various embodiments, analysis engines, or the like may be arranged to monitor telemetry information associated with one or more users.

Accordingly, in some embodiments, analysis engines, or the like may be arranged to provide one or more user interface facilities to collect direct feedback from one or more of the users that may interact with information displayed in the one or more user interfaces. In some embodiments, user interfaces may include controls that enable authorized users to grade one or more manufacture plans, manufacture instructions, design evaluation reports, or the like. In some embodiments, grades or scores may be binary (e.g., like/dislike), discrete (e.g., one-four stars, letter grades), continuous values, or the like.

In one or more of the various embodiments, analysis engines, or the like may be arranged to provide user interfaces that monitor how users interact with manufacture plans, design job reports, manufacture results, manufacture and design instructions, or the like. In some embodiments, telemetry information employed to monitor user preferences may be based on monitoring user interactions as well as direct feedback. Accordingly, in some embodiments, manufacture plans, design evaluation reports, manufacture results, manufacture and design instructions, or the like, that may appear valid or reasonable but are ignored or discarded by users may be inferred to be poorly received. In some embodiments, if the top ranked results provided in response to user actions, user queries, evaluation results, or the like, are ignored or lower ranked results are favored by users, it may be inferred that there may be a problem with the data or the display of the data. Further, in some embodiments, analysis engines, or the like may be arranged to receive telemetry information from other services or applications.

Accordingly, in some embodiments, analysis engine 902, or the like may be arranged to collect metrics or telemetry associated with user interactions with user interface 936 or user interface 932 using a one or more of input/output interface 238, cameras 240, touch interface 244, keypad 252, audio interface 256, GPS, 258, open air gesture interface 260, haptic interface 264, pointing device interface 266, or the like, of client computer 200 as discussed in regard to FIG. 2. In some embodiments, analysis engine 902, or the like may be arranged to collect metrics or telemetry associated with user interactions with user interface 936, or user interface 932 using a one or more of input/output interface 338, GPS 340, keyboard 352, audio interface 356, pointing device interface 358, or the like, of network computer 300 as discussed in regard to FIG. 3.

In some embodiments, analysis engines, or the like may be arranged to track mouse movement, eye movement, keystrokes, or the like, to determine how users may interact with information (e.g., job plans, reports, job results, job instructions, or the like) displayed in user interfaces. Accordingly, in some embodiments, analysis engines, or the like may be arranged to evaluate at least the quality of various design and manufacture recommendations, agent delegation, design evaluation report characteristics, or the like based on how users interact with them via the user interfaces. In some embodiments, if users consistently select or otherwise favor interacting with displayed items ranked or listed lower than others, it may indicate that one or more systems performing the ranking or reporting may be experiencing diminished or diminishing effectiveness. In some embodiments, users may reject or ignore displayed items which may indicate that one or more associated systems may be experiencing diminished or diminishing effectiveness.

In some embodiments, analysis engines, or the like may be arranged to associate a performance score with user interfaces used in the system based on the user interaction metrics or telemetry. Accordingly, in some embodiments, if the performance score associated with a user interface or user interface element falls below a defined threshold value, analysis engines, or the like may be arranged to suspend those user interfaces (or portions thereof) from operation. In some embodiments, analysis engines, or the like may be arranged to automatically modify the deficient user interfaces.

In some embodiments, telemetry engines may be arranged to collect or determine telemetry information that includes user telemetry, user feedback, or telemetry metrics that may be used to dynamically transform user interfaces, display panels, and the like. In some embodiments, the dynamic transformation may include arrangement, re-arrangement, elimination, addition, or adaptation of content and visual elements in user interfaces and display panels based on at least the collected telemetry information.

In some embodiments, telemetry engines may collect metrics associated with the one or more user interactions with the system including content within the user interfaces and display panels. In some embodiments, user profiles may be configured to dynamically include user interface preferences based on collected user telemetry metrics and user feedback. Accordingly, in some embodiments, analysis engines, or the like may dynamically change the visual appearance of the user interfaces to improve the efficiency and effectiveness of the system or its user interfaces for the user.

In some embodiments, analysis engines may be arranged to dynamically select, position, size, shape, remove, hide, inactivate, disable, highlight, or style one or more visual user interface components such as display panels, controls, elements or content based on one or more of user telemetry metrics and user feedback. In some embodiments, if user interactions with the user interface are tracked focusing on or navigating to particular user interface views, components or user interface panels, system components, such as analysis engines, may be arranged to dynamically highlight or size the preferred user interface elements and/or display panels. In some embodiments, if customers and/or administrative users are determined to rarely interact with a user interface element, such as elements, 940, 942, 944 or 946, analysis engines, or the like may be arranged to dynamically reduce the size, diminish the shape, disable its controls, or re-position elements 940, 942, 944 and/or 946 by displaying a smaller sized greyed out version of one or more elements in its corresponding display panel.

In some embodiments, analysis engines, or the like may be arranged to adapt user interfaces based on the size/type of display, input methods, user status, or the like. In some embodiments, if a user is determined to be operating using a mobile device, one or more user interface elements may be dynamically positioned differently. In some cases, depending on the display type or display size, one or more user interface elements may be hidden from view. In some embodiments, an analysis engine may be arranged to dynamically modify or re-arrange user interfaces 932 or 936 based on telemetry associated with the other user interface or associated customer/administrative user interactions. Although not shown in the figures, display panel 938 within user interface 936 may be dynamically modified or rearranged to accommodate a modified physical orientation of the user interface or a change in the number of displayed elements, such as displaying three elements instead of two elements. Further, the physical orientation may be modified from landscape (horizontal) to a portrait (vertical) orientation based on one or more telemetry metrics.

Thus, in some embodiments, analysis engines, or the like may be arranged to tangibly modify user interfaces, display panels, interactive reports, input collection, input selection, input data representation, or the like, based on the efficient and effective performance of processes and/or activities associated with various types input information, manufacture information, design information, agent delegation, or the like as determined by telemetry information, or the like.

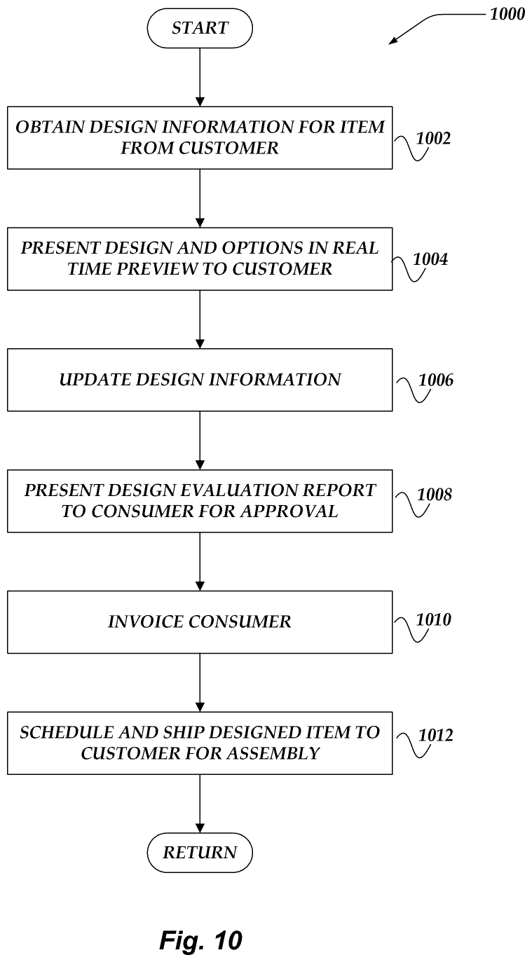

FIG. 10 illustrates a flow chart of an overview of a process 1000 for automating the real time design, manufacturing and shipping of components for a customized item of furniture that is designed by a user/customer. Moving to block 1002, the process obtains design information from the user/customer regarding one or more custom design elements for an item of furniture. In one or more embodiments, the customer may provide, by a user interface, the design information in one or more forms, including text descriptions, images, audio recordings, movies, video, sketches, illustrations, drawings, budgets, styles, colors, materials, surface finishes, decorative elements, or the like.

At block 1004, the process ingests the design information and then presents a real time display of a three-dimensional preview of the item. The preview may also include one or more potential shipping dates of the item, cost estimates, and/or recommendations to add, modify, or replace some or all of the custom design elements based on one or more of heuristics, previously manufactured items of similarly designed furniture, costs, or new design elements that are recently available.

At block 1006, edits to the design information provided by the user/customer are employed to iteratively update the displayed preview in real time until the user stops editing and an interim custom design is accepted. Next, at block 1008, a report is provided that evaluates all aspects of the custom design of the item of furniture for approval of a final custom design by the user/customer.

At block 1010, an invoice for the user/customer is obtained for payment based on their approval of the report. Stepping to block 1012, upon payment or financing of the invoice by the user/customer, the final custom design of the item of furniture is scheduled for manufacture and an estimated shipping date is provided to the user/customer. Next, the process flows to the return block continues performing other processes.

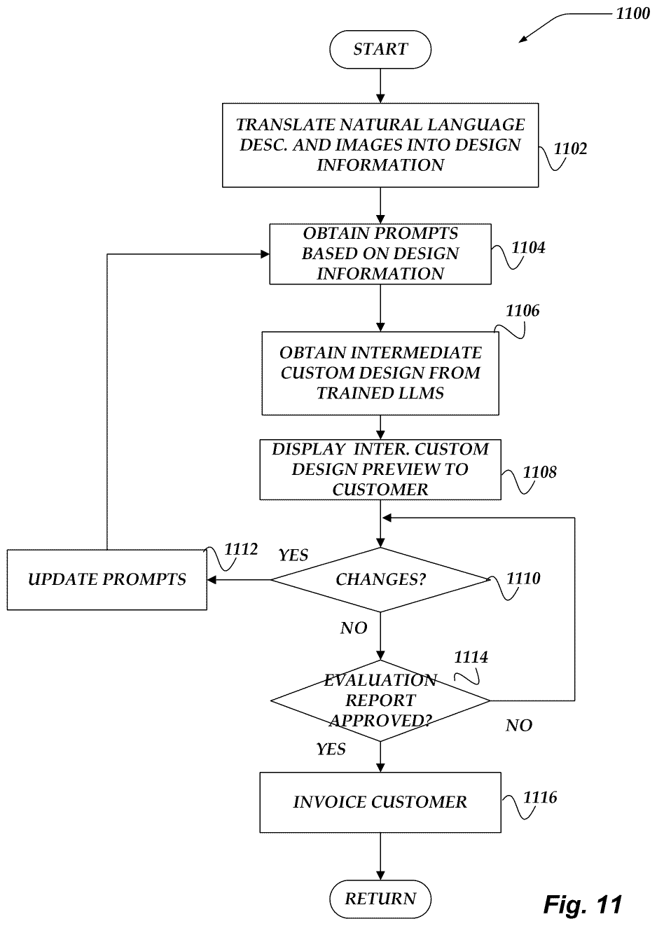

FIG. 11 illustrates a flow chart of an overview of process 1100 for using generative Artificial Intelligence, agents and large language models to automate one or more portions of the real time design, manufacturing and shipping of components for a customized item of furniture that is selected and/or designed by a user/customer.

Moving to block 1102, the process obtains design information from the user/customer regarding one or more custom design elements for an item of furniture. In one or more embodiments, the customer may provide, by a user interface, the design information in one or more forms, including text descriptions, images, audio recordings, movies, video, sketches, illustrations, drawings, budgets, styles, colors, materials, surface finishes, decorative elements, or the like.

At block 1104, one or more agents employ the model context protocol, or the like, to obtain the design information for use with one or more prompts associated with one or more large language models. Next, at block 1106, an intermediate custom design of the item of furniture is obtained based on training of the one or more large language models with the one or more prompts.

At block 1108, a display of a preview for the intermediate custom design is provided to the customer/user. At decision block 1110, if the customer requests changes to the intermediate custom design, the process moves to block 1112 where the one or more prompts are updated based on the customer requested changes. Then the process looks back to block 1104 and continues the associated process as laid out above.

However, if the customer does not request changes at decision block 1110, the process flows to decision block 1114 for approval of a report, by the customer/user, for the final custom design of the item of furniture. If not approved by the customer, the process loops back to decision block 1110 and continues the associated process.

Alternatively, at decision block 1114, if the customer/user approves the report, then the process moves to block 1116, where an invoice for the user/customer is obtained for payment based on their approval of the report. Upon payment or financing of the invoice by the user/customer, the final custom design of the item of furniture is scheduled for manufacture and an estimated shipping date is provided to the user/customer. Next, the process flows to the return block and continues performing other processes.

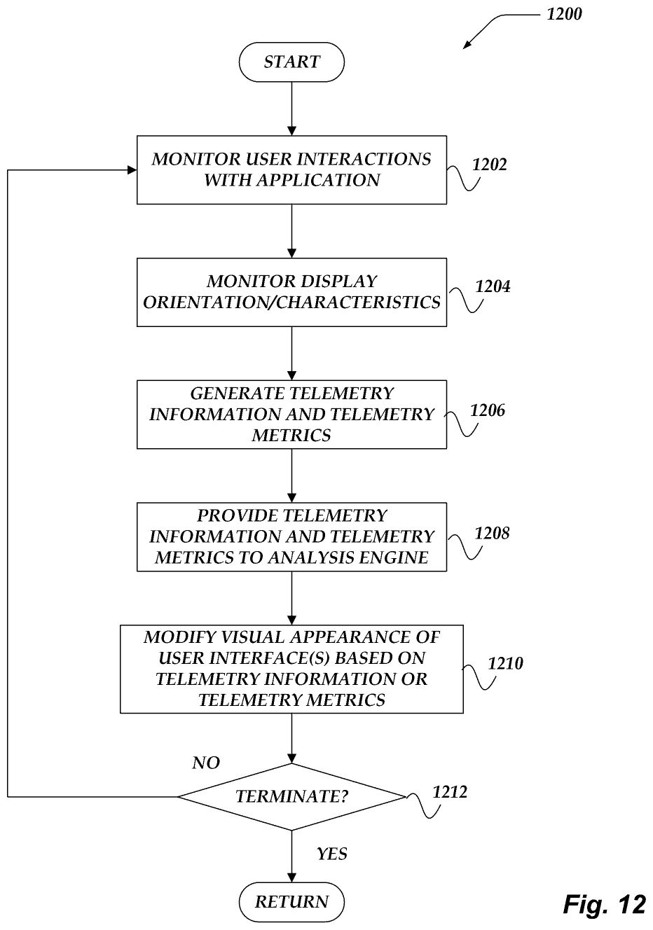

FIG. 12 illustrates a flowchart of process 1200 for collecting and applying telemetry information and telemetry metrics for real time construction job analysis and evaluation in accordance with one or more of the various embodiments. After a start block, at block 1202, in one or more of the various embodiments, telemetry engines may be arranged to monitor one or more user interactions with one or more applications. As described above, telemetry engines may be arranged to monitor or track how users may physically interact with one or more user interfaces associated with the one or more applications. In some embodiments, user interactions may include active interactions associated with user activity or passive interactions associated with user inactivity. Also, in one or more embodiments, various types of collected user telemetry may be based on a user's selection or non-selection of one or more particular elements or content in a display panel, pointing device (mouse) hover time over particular content or elements in a display panel, user dwell time between actions in a display panel, dwell time for viewing a display panel by a user, and the like. Also, in some embodiments, telemetry engines may be arranged to track mouse movement, eye movement, keystrokes, or the like, to determine how users may interact with information displayed in user interfaces. See FIG. 9 for more information about the user interfaces.

At block 1204, in one or more of the various embodiments, telemetry engines may be arranged to monitor one or more display characteristics or display orientation characteristics.

As described above, in some embodiments, telemetry engines may be arranged to monitor various display characteristics employed for displaying the user interfaces, including the size/type of display, screen resolution, screen orientation, number of active displays, screen brightness, refresh rate, aspect ratio, color dynamic range, windowed or full screen modes, or the like. In some embodiments, screens, monitors, or operating systems may provide interfaces or APIs that enable telemetry engines to obtain information about the current state or status of the display screen. In some cases, for some embodiments, operating systems or other services may be configured to actively notify telemetry engines if one or more screen characteristics may change.

At block 1206, in one or more of the various embodiments, telemetry engines may be arranged to generate telemetry information or one or more telemetry metrics. In some embodiments, the monitored interactions or display characteristics may be represented as telemetry information or telemetry metrics. The particular format of the telemetry information or telemetry metrics may vary depending on the type interactions or characteristics being represented. Accordingly, in some embodiments, telemetry information or telemetry metrics may be included in one or more data structures that may be communicated to other applications or services. For example, in some embodiments, telemetry information or telemetry metrics may be represented using key-value pair data structures that include a key field representing the label or type of metric and a value field that represents the value of the metric.

At block 1208, in one or more of the various embodiments, telemetry engines may be arranged to provide the telemetry information and telemetry metrics to a runtime engine.

In some embodiments, telemetry engines may be arranged to provide one or more interfaces or APIs that enable other applications or services, such as analysis engines, threat hunting engines, or the like, to gain access to the telemetry information or telemetry metrics. In some embodiments, telemetry engines may be configured to push some or all of the telemetry information or telemetry metrics to one or more subscribing application or services. Also, in some embodiments, telemetry engines may be configured to enable other application or services to poll or otherwise request-on-demand some or all of the telemetry information or telemetry metrics.

At block 1210, in one or more of the various embodiments, analysis engines or threat hunting engines may be arranged to modify the visual appearance of one or more user interfaces based on the telemetry information or telemetry metrics.

Accordingly, in some embodiments, analysis engines may be arranged to dynamically change the visual appearance of the one or more user interfaces to improve the efficiency and effectiveness of the user interfaces based on some or all of the telemetry information or telemetry metrics. For example, analysis engines may be arranged to dynamically select, position, size, shape, remove, hide, inactivate, disable, highlight, or style one or more visual user interface components such as display panels, controls, elements, or content based on, among other things, one or more telemetry metrics. For example, if telemetry information or telemetry metrics indicate that users are focusing on or navigating to particular user interface views, components or user interface panels, analysis engines may be arranged to highlight or size the preferred user interface elements or display panels. For example, if users are determined to rarely interact with a particular display panel, analysis engines may be arranged to reduce the size, diminish the shape, disable its controls, and re-position that display panel to improve the efficiency of display screen usage. See, also FIG. 9 and its description.

At decision block 1212, in one or more of the various embodiments, if the telemetry engine or analysis engine may be terminated, control may be returned to a calling process; otherwise, control may loop back to block 1202. In some embodiments, telemetry engines may be arranged to continuously or periodically provide updated/current telemetry information or telemetry metrics to enable analysis engines or threat hunting engines to dynamically change the visual appearance of the one or more user interfaces. Accordingly, in some embodiments, process 1400 may continue operation until it may be explicitly terminated or the operation of the associated analysis engines may be terminated.

It will be understood that each block of the flowchart illustrations or combinations of blocks in these flowchart illustrations, may be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware based systems, which perform the specified actions or steps, or combinations of special purpose hardware and computer instructions. The foregoing example should not be construed as limiting or exhaustive, but rather, an illustrative use case to show an implementation of at least one of the various embodiments of the invention.

Further, in one or more embodiments (not shown in the figures), the logic in the illustrative flowcharts may be executed using an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. In one or more embodiments, a microcontroller may be arranged to directly execute its own embedded logic to perform actions and access its own internal memory and its own external Input and Output Interfaces (e.g., hardware pins or wireless transceivers) to perform actions, such as System On a Chip (SOC), or the like.

What is claimed as new and desired to be protected by Letters Patent of the United States of America is:

1. A method for automatic design and manufacture of furniture, comprising:
collecting design information for one or more items of furniture based on content and information received from one or more sources;
employing one or more user interfaces to display one or more preview visualizations of the one or more items of furniture based on the design information, wherein the display of the one or more preview visualizations is iteratively updated based on one or more edits to one or more of the design information, or the one or more preview visualizations;
employing an approval of a design evaluation report to automatically initiate manufacture of the one or more items of furniture, wherein the manufacture includes automatically forming a plurality of particular mortice and tenon compression joins in one or more materials for the one or items of furniture, wherein the compression joins enable a user to efficiently assemble one or more sub-components of the one or more items of furniture without use of one or more of a fastener or an adhesive; and
wherein the one or more user interfaces include one or more display panels for content that includes one or more of a design evaluation report, a visualization, a recommendation, or other information associated with the one or more items of furniture, wherein the content is dynamically transformed and arranged for display to the user based on one or more of user interaction telemetry, user feedback or telemetry metrics.

2. The method of claim 1, wherein forming the plurality of mortice and tenon compression joins, further comprises:
manufacturing each compression join based on one or more of a size, a weight, a shape, a material, or a clearance of each sub-component of the item of furniture, wherein the plurality compression joins are used to assemble each sub-component into the item of furniture.

3. The method of claim 1, further comprising:
automatically transmitting an invoice to the user for the one or more items of furniture based on the approval of the design evaluation report, wherein the invoice includes one or more costs for manufacture and delivery of the one or more items of furniture to the user.

4. The method of claim 1, wherein the automatic initiation of manufacture, further comprises:
obtaining a plurality of computer numerical control (CNC) instructions to direct one or more manufacturing machines to form the plurality of particular mortice and tenon compression joins in the one or more selected materials for the one or items of furniture.

5. The method of claim 1, wherein the one or more materials further comprise:
a solid material, including veneer plywood, plywood, solid wood, particle board wood, metal, plastic, stone, polymer, or composite materials; or
a state change material associated with a state change from a liquid to a solid at ambient temperatures, including concrete, metal, ceramics, plastic, polymers, or composite material.

6. The method of claim 1, further comprising:
employing one or more computer numerical control (CNC) machines to automatically manufacture the one or more items of furniture from one or more of a solid material, a state change material, or a printable material.

7. The method of claim 1, further comprising:
obtaining one or more recommendations to update the design of one or more items of furniture based on one or more of heuristic information, cost, or a type of material.

8. The method of claim 1, further comprising:
obtaining one or more adhesives to be used with one or more portions of the plurality of compression joins, wherein the one or more adhesives are employed to prevent disassembly of the one or more sub-components of the one or more items of furniture.

9. The method of claim 1, further comprising:
training one or more large language models with the collected design information; and
employing the one or more trained large language models to obtain an intermediate design of the one or more items of furniture.

10. The method of claim 9, further comprising employing a model context protocol (MCP) to collect the design information to train the one or more large language models.

11. A computer for automating design and manufacture of furniture, comprising:
a memory for storing instructions; and
one or more processors that execute the instructions to cause actions, including:
collecting design information for one or more items of furniture based on content and information received from one or more sources;
employing one or more user interfaces to display one or more preview visualizations of the one or more items of furniture based on the design information, wherein the display of the one or more preview visualizations is iteratively updated based on one or more edits to one or more of the design information, or the one or more preview visualizations;
employing an approval of a design evaluation report to automatically initiate manufacture of the one or more items of furniture, wherein the manufacture includes automatically forming a plurality of particular mortice and tenon compression joins in one or more materials for the one or items of furniture, wherein the compression joins enable a user to efficiently assemble one or more sub-components of the one or more items of furniture without use of one or more of a fastener or an adhesive; and
wherein the one or more user interfaces include one or more display panels for content that includes one or more of a design evaluation report, a visualization, a recommendation, or other information associated with the one or more items of furniture, wherein the content is dynamically transformed and arranged for display to the user based on one or more of user interaction telemetry, user feedback or telemetry metrics.

12. The computer of claim 11, wherein forming the plurality of mortice and tenon compression joins, further comprises:
manufacturing each compression join based on one or more of a size, a weight, a shape, a material, or a clearance of each sub-component of the item of furniture, wherein the plurality compression joins are used to assemble each sub-component into the item of furniture.

13. The computer of claim 11, further comprising:
automatically transmitting an invoice to the user for the one or more items of furniture based on the approval of the design evaluation report, wherein the invoice includes one or more costs for manufacture and delivery of the one or more items of furniture to the user.

14. The computer of claim 11, wherein the automatic initiation of manufacture, further comprises:
obtaining a plurality of computer numerical control (CNC) instructions to direct one or more manufacturing machines to form the plurality of particular mortice and tenon compression joins in the one or more selected materials for the one or items of furniture.

15. The computer of claim 11, wherein the one or more materials further comprise:
a solid material, including veneer plywood, plywood, solid wood, particle board wood, metal, plastic, stone, polymer, or composite materials; or
a state change material associated with a state change from a liquid to a solid at ambient temperatures, including concrete, metal, ceramics, plastic, polymers, or composite material.

16. The computer of claim 11, further comprising:
employing one or more computer numerical control (CNC) machines to automatically manufacture the one or more items of furniture from one or more of a solid material, a state change material, or a printable material.

17. The computer of claim 11, further comprising:
obtaining one or more recommendations to update the design of one or more items of furniture based on one or more of heuristic information, cost, or a type of material.

18. The computer of claim 11, further comprising:
obtaining one or more adhesives to be used with one or more portions of the plurality of compression joins, wherein the one or more adhesives are employed to prevent disassembly of the one or more sub-components of the one or more items of furniture.

19. The computer of claim 11, further comprising:
training one or more large language models with the collected design information; and
employing the one or more trained large language models to obtain an intermediate design of the one or more items of furniture.

20. The computer of claim 19, further comprising employing a model context protocol (MCP) to collect the design information to train the one or more large language models.
